(19) United States
(12) Patent Application Publication
(10) Pub. No.: US 2010/0279886 A1
(43) Pub. Date: Nov. 4, 2010

(54) TWO-DIMENSIONAL PHOTONIC BANDGAP STRUCTURES FOR ULTRAHIGH-SENSITIVITY BIOSENSING

(75) Inventors: Philippe M. FAUCHET, Pittsford, NY (US); Mindy R. LEE, Rochester, NY (US); Benjamin L. MILLER, Penfield, NY (US)

Correspondence Address: NIXON PEABODY LLP - PATENT GROUP, 1100 CLINTON SQUARE, ROCHESTER, NY, 14604, US

(73) Assignee: UNIVERSITY OF ROCHESTER, Rochester, NY (US)

(21) Appl. No.: 12/062,202

(22) Filed: Apr. 3, 2008

Related U.S. Application Data
(60) Provisional application No. 60/909,899, filed on Apr. 3, 2007.

(51) Int. Cl. C40B 30/04; C40B 40/08; C40B 50/18

(52) U.S. Cl. 506/9; 506/17; 506/32

(57) ABSTRACT

The present invention relates to two-dimensional photonic crystal arrays and their use in biological sensor chips, including those in the form of microfluidic devices. Methods of making the two-dimensional photonic crystals and biological sensor chips are described herein, as are uses of these devices to detect biological targets in samples.

This application claims the benefit of U.S. Provisional Patent Application Ser. No. 60/909,899, filed Apr. 3, 2007, which is hereby incorporated by reference in its entirety.

### STATEMENT OF GOVERNMENT SPONSORSHIP

The present invention was made with funding received from the National Science Foundation under Grant No. BES 04279191. The U.S. government has certain rights in the invention.

### FIELD OF THE INVENTION

The present invention relates to photonic crystal (PhC) arrays and their use in biological sensor chips, methods of making these products, and their use in detecting biological targets in samples.

### BACKGROUND OF THE INVENTION

Early detection and identification of biological substances are pursued with great interest for many applications. Label-free optical biosensing is one of the fastest growing research areas (Liedberg et al., “Principles of Biosensing With an Extended Coupling Matrix and Surface Plasmon Resonance,” Sens. Actuators B 11:63-72 (1993); Saarinen et al., “Optical Sensor Based on Resonant Porous Silicon Structures,” Opt. Express 13:3754-3764 (2005); Lin et al., “A Porous Silicon-Based Optical Interferometric Biosensor,” Science 278:840-843 (1997); Cunin et al., “Biomolecular Screening With Encoded Porous-Silicon Photonic Crystals,” Nat. Mater. 1:39-41 (2002); Chan et al., “Porous Silicon Microcavities for Biosensing Applications,” Phys. Stat. Sol. A. 182:541-546 (2000); Chan et al., “Identification of Gram Negative Bacteria Using Nanoscale Silicon Microcavities,” J. Am. Chem. Soc. 123:11797-11798 (2001); Ouyang et al., “Macroporous Silicon Microcavity for Macromolecule Detection,” Adv. Funct. Mater. 15:1851-1859 (2005); Cunningham et al., “Colorimetric Resonant Reflection as a Direct Biochemical Assay Technique,” Sens. Actuators B 81:316-328 (2002); and Block et al., “Photonic Crystal Optical Biosensor Incorporating Structured Low-Index Porous Dielectric,” Sens. Actuators B 120:187-193 (2006)), because it does not require the use of radioactive/fluorescent labels that introduce complexity and potential contamination to biological material in vivo. The well developed label-free platforms include surface plasmon resonance (“SPR”) (Liedberg et al., “Principles of Biosensing With an Extended Coupling Matrix and Surface Plasmon Resonance,” Sens. Actuators B 11:63-72 (1993)), waveguides (Saarinen et al., “Optical Sensor Based on Resonant Porous Silicon Structures,” Opt. Express 13:3754-3764 (2005)), one-dimensional photonic bandgap structures of increasing complexity, ranging from simple Bragg reflectors (Lin et al., “A Porous Silicon-Based Optical Interferometric Biosensor,” Science 278:840-843 (1997)) and rugate filters (Cunin et al., “Biomolecular Screening With Encoded Porous-Silicon Photonic Crystals,” Nat. Mater. 1:39-41 (2002)) to microcavities (Chan et al., “Porous Silicon Microcavities for Biosensing Applications,” Phys. Stat. Sol. A. 182:541-546 (2000); Chan et al., “Identification of Gram Negative Bacteria Using Nanoscale Silicon Microcavities,” J. Am. Chem. Soc. 123:11797-11798 (2001); and Ouyang et al., “Macroporous Silicon Microcavity for Macromolecule Detection,” Adv. Funct. Mater. 15:1851-1859 (2005)) built with porous silicon, and colorimetric imaging obtained from off-plane illumination on a diffractive grating surface/photonic crystal (Cunningham et al., “Colorimetric Resonant Reflection as a Direct Biochemical Assay Technique,” Sens. Actuators B 81:316-328 (2002); Block et al., “Photonic Crystal Optical Biosensor Incorporating Structured Low-Index Porous Dielectric,” Sens. Actuators B 120:187-193 (2006); and Sonek, G. J., “Integrated Photonic Crystal Waveguides for Micro-Bioanalytical Devices,” in Proceedings of IEEE Conference on Microtechnologies in Medicine and Biology, pp. 333-336 (IEEE, 2005)). One common problem is that these structures require a well-collimated readout beam and, hence, a relatively large sensing area.

Photonic crystals (PhCs) are an attractive sensing platform because they provide strong light confinement. Unlike many sensing platforms that utilize the interaction between the small evanescent tail of the electromagnetic field and the analyte, PhCs can be designed to localize the electric field in the low refractive index region (e.g., air pores), which makes the sensors extremely sensitive to a small refractive index change produced by bio-molecule immobilization on the pore walls. By introducing a point defect into a PHC, defect states can be pulled down from the air band or up from the substrate band. The corresponding optical spectrum shows narrow transmission peaks inside the bandgap, whose precise position is determined by the refractive index of the pores. Thus, the presence of molecules inside the pores can be detected by monitoring a small spectral shift, especially if high-Q microcavities, which have been reported both theoretically (Srinivasan et al., “Momentum Space Design of High-Q Photonic Crystal Optical Cavities,” Opt. Express 10:670-684 (2002)) and experimentally (Akahane et al., “High-Q Photonic Nanocavity in a Two-Dimensional Photonic Crystal,” Nature 425:944-947 (2003)), are used.

One-dimensional (1-D) PhCs and PhC microcavities based on porous silicon have been used extensively for the detection of DNA (Chan et al., “Porous Silicon Microcavities for Biosensing Applications,” Phys. Stat. Sol. A. 182:541-546 (2000)), proteins (Ouyang et al., “Macroporous Silicon Microcavity for Macromolecule Detection,” Adv. Funct. Mater. 15:1851-1859 (2005)), and even bacteria (Chan et al., “Identification of Gram Negative Bacteria Using Nanoscale Silicon Microcavities,” J. Am. Chem. Soc. 123:11797-11798 (2001)). An annular Bragg mirror microcavity (J. Scheuer, W. M. J. Green, G. DeRose, and A. Yariv, in CLEO/QELS Conference 2005 (Optical Society of America, 2005), postdeadline paper CPDA7) has also been proposed as an alternative approach for detecting ambient refractive index changes. One general problem is that a well-collimated beam is needed for all these approaches, especially for high-quality-factor devices, which requires that the sensing area be relatively large.

Recently, 2-D PhC microcavities, formed by introducing a defect in an otherwise perfectly periodic structure (Chow et al., “Ultracompact Biochemical Sensor Built With Two-Dimensional Photonic Crystal Microcavity,” Opt. Lett. 29:1093-1095 (2004)), have shown great promise for chemical and biological sensing (Sonek, G. J., “Integrated Photonic Crystal Waveguides for Micro-Bioanalytical Devices” in Proceedings of IEEE Conference on Microtechnologies in Medicine and Biology, pp. 333-336 (IEEE, 2005)). The minimum amount of protein that can be detected by these devices is greater than several femtogram. This detection limit, though much improved over predecessor devices, may still be too high when the goal is to detect very low copy numbers of a virus, for instance.

Detection of very low copy numbers of HIV in patient samples is of interest for understanding the mechanism(s) whereby low levels of the virus persist in the body following antiretroviral therapy (Maldarelli et al., “ART Suppresses Plasma HIV-1 RNA to a Stable Set Point Predicted by Pretherapy Viremia,” PLoS Pathogens 3:484-488 (2007)), and the relationship of “undetectable” levels of drug-resistant mutants of the virus to subsequent failures in therapy (Halvas et al., “Blinded, Multicenter Comparison of Methods to Detect a Drug-resistant Mutant of Human Immunodeficiency Virus Type 1 at Low Frequency,” J. Clin. Microbiol. 44:2612-2614 (2006)). Current point-of-care diagnostic methods (such as the “OraQuick” test) primarily focus on detecting antibodies to HIV, rather than on detection of the virus itself. For detecting very low viral titers (ca. 1 copy/ml), this is not viable. Instead, an effective, but cumbersome and expensive, PCR-based assay is used (Palmer et al., “New Real-time Reverse Transcriptase-initiated PCR Assay with Single-copy Sensitivity for Human Immunodeficiency Virus Type 1 RNA in Plasma,” J. Clin. Microbiol. 41:4531-4536 (2003)). Similarly, ultrasensitive detection of other viral pathogens, including H5N1 influenza (“bird flu”) (Dawson et al., “MChip: A Tool for Influenza Surveillance,” Anal. Chem. 78:7610-7615 (2006)), and the SARS (Severe Acute Respiratory Syndrome) virus (Li et al., “Multiplexed Detection of Pathogen DNA with DNA-based Fluorescence Nanobarcodes,” Nature Biotechnol. 23:885-889 (2005)), remains a widely recognized research goal (Ymeti et al., “Fast, Ultrasensitive Virus Detection Using a Young Interferometer Sensor,” Nano Lett. 7:394-397 (2007)). For many bacteria, a single viable cell or spore is sufficient to cause serious illness. Therefore, a need exists for the development of a label-free biosensor capable of detecting single virus particles and single cells or spores of bacterium.

The present invention is directed to overcoming these and other deficiencies in the art.

### SUMMARY OF THE INVENTION

A first aspect of the present invention relates to a two-dimensional photonic crystal biosensor chip that includes: a substrate including a surface having a lattice array of substantially aligned pores therein to form a photonic crystal, the surface also having two or more central defects formed in the lattice array, where the two or more central defects are characterized by resonance modes at different wavelengths of light; and one or more probes bound to surfaces of the substrate exposed to the two or more central defects; wherein binding of a target to the one or more probes causes a detectable change in a refractive index of the biosensor chip.

A second aspect of the present invention relates to a two-dimensional photonic crystal biosensor chip that includes: a substrate including a surface having a lattice array of substantially aligned pores therein to form a photonic crystal, the surface also having a central defect formed in the lattice array, where the central defect is characterized by a radius that is about the distance of (a-d/2) or greater, where a is the lattice constant of the lattice array and d is the diameter of the pores of the array; and one or more probes bound to a surface of the substrate exposed to the central defect; wherein binding of a target to the one or more probes causes a detectable change in a refractive index of the biosensor chip.

A third aspect of the present invention relates to a two-dimensional photonic crystal biosensor chip that includes: a substrate including a surface having a lattice array of substantially aligned pores therein to form a photonic crystal, the surface also having a central defect formed in the lattice array, where the central defect is a closed-loop structure; and one or more probes bound to a surface of the substrate exposed to the central defect; wherein binding of a target to the one or more probes causes a detectable change in a refractive index of the biosensor chip.

A fourth aspect of the present invention relates to a sensor device that includes a biosensor chip according to any of the first, second, or third aspects of the invention; a light source including a first optical waveguide optically coupled to deliver light across the photonic crystal of the biosensor chip; and a detector including a second optical waveguide optically coupled to receive light output from the photonic crystal of the biosensor chip, wherein the detector can light output from the photonic crystal via the second optical waveguide.

A fifth aspect of the present invention relates to a method of making a biosensor chip according to the first, second, or third aspects of the invention. The method includes: preparing an array of substantially aligned pores in a substrate to form a photonic crystal having the central defect; and coupling one or more probes to a surface of the substrate exposed to the central defect.

A sixth aspect of the present invention relates to a method of detecting a biological target that includes: providing a sensor device according to the fourth aspect of the present invention; exposing the sensor device to a sample containing a biological target; and detecting a property of light emitted from the second waveguide, whereby detection of the property indicates presence of the biological target in the sample.

A seventh aspect of the present invention relates to a method of detecting a biological target that includes: providing a sensor device according to the fourth aspect of the present invention; exposing the sensor device to a sample containing a biological target; detecting a property of light emitted from the second waveguide, whereby detection of the property indicates presence of the biological target in the sample; and further detecting any Raman scattering of light emitted from the biosensor chip.

An eighth aspect of the present invention relates to a method of identifying a biological target that includes performing the method according to the seventh aspect of the present invention and determining whether the detected Raman scattering confirms the identity of the biological target whose presence is detected by the property of light emitted from the second waveguide.

A ninth aspect of the present invention relates to a method of quantifying the amount of a biological target present in a sample that includes: providing a sensor device according to the fourth aspect of the present invention; exposing the sensor device to a sample containing a biological target; and detecting a change in the refractive index of the biosensor chip, wherein a change in the refractive index indicates presence of the biological target in the sample and the amount of biological target is quantifiable based on the extent of the wavelength shift of light transmitted through the photonic crystal.

Several 2-D photonic crystal biosensors according to the present invention have been constructed with a sensing area of ˜40 μm², which is one of the most compact designs reported so far. These photonic crystal biosensors can detect a very small amount of analyte. Moreover, the in-plane light propagation geometry of Si photonic crystals and the use of mature microelectronic fabrication techniques make them better suited for integration with electronic/photonic components on a single chip. Using a modified design of the microcavity, several embodiments of the photonic crystal biosensors are ideally suited for the detection of single particles that fall within the size range of various viruses of interests.

### BRIEF DESCRIPTION OF THE DRAWINGS

FIGS. 1A-D illustrate several designs of two-dimensional photonic crystal arrays for use as biological sensor chips. FIG. 1A is a scanning electron microscopy (SEM) image of a crystal array according to one embodiment of the invention, which includes a central defect having a diameter that is roughly the same size as the lattice constant of the crystal array. FIG. 1B is a model of an array according to a second embodiment of the invention, which includes two or more central defects characterized by different size. Cavity A has a defect radius of r_{A}=0.1 a, and cavity B has a defect radius of r_{B}=0.2 a. Adjacent cavities are separated by a period of pores. FIG. 1C is an SEM image of an array according to a third embodiment of the invention, which includes a central defect that is ring-shaped. FIG. 1D is a model of an array according to a fourth embodiment of the invention, which includes a pair of defects each of which has a diameter that is roughly the same size as the lattice constant of the crystal array. These defects are separated by four periods of pores.

FIG. 2 is a graph illustrating the degree of cross-talk between the multiple defects of multi-defect sensor devices as a function of the separation (by number of periods of pores) between adjacent defects.

FIGS. 3A-B illustrates a schematic of the field confinement, and red-shift versus coating thickness on the pore walls. FIG. 3A shows a schematic of field confinement in a 2-D PhC microcavity (the scales are in μm). The electric field amplitude is greatest at the defect. FIG. 3B shows the resonance red-shift versus coating thickness on the pore walls. The () curve shows the red-shift due to the uniform infiltration of bio-molecules in all the pores. The (▴) curve shows the red-shift due to the infiltration only in the central defect.

FIG. 4 illustrates an experimental setup for a sensor device of the present invention. A tunable laser (1440 nm to 1590 nm) is used as the light source, and light is coupled in and out of the photonic crystal using tapered ridge waveguides. A polarization controller is used to maximize the TE mode signal, and an InGaAs detector is used to measure the transmission signal.

FIG. 5 illustrates a microfluidic device that incorporates a sensor chip of the present invention such that the fluid sample can flow over the defect region of the crystal array to allow for binding of any target to probes. The outlet or inlet of the microfluidic device is also shown in-line with filter membranes that act as pre-filtration or concentration aids.

FIGS. 6A-B illustrate a schematic of the microfluidic channel fabrication using SU-8. FIG. 6A shows the structuring of SU-8 layers to form the channel support, and FIG. 6B shows the bonding of SU-8 channel support onto the substrate containing the photonic crystal structure.

FIG. 7 illustrates an approach for fabricating the channel support using polydimethylsiloxane (“PDMS”) soft lithography. After fabricating the PDMS channel support, the channel support is bonded onto the substrate in the manner shown in FIG. 6B.

FIG. 8 is an SEM image of a photonic crystal array having a central defect with a diameter (140 nm) that is smaller than the pore diameter, d (270 nm), and lattice constant, a (465 nm).

FIGS. 9A-B show a schematic of bio-molecule recognition. In FIG. 9A, the target molecules are captured by the probe molecules. In FIG. 9B, the bio-molecules form a uniform layer on the internal surface of the sensor. In reality the layer thickness is very small compared with the pore size.

FIG. 10 illustrates the normalized transmission spectra of the PhC microcavity shown in FIG. 8. Curve (a) indicates the initial spectrum resonance after oxidation and silanization, curve (b) was measured after glutaraldehyde attaches to the pore walls, and curve (c) was obtained after infiltration of BSA molecules.

FIGS. 11A-B illustrate the PhC microcavity resonance red-shift calculations. FIG. 11A shows the calculated resonance red-shift versus the monolayer coating thickness on the pore wall (upper curve), bottom (middle curve), and top of the device (lower curve). In FIG. 11B, the curve shows the calculated resonance red-shift versus the coating thickness on the pore wall. The dots show the protein layer thicknesses as measured by ellipsometer, which is in agreement with the model.

FIGS. 12A-B show the sensitivity and selectivity of the PhC microactivity biosensor for streptavidin, having the structure of the sensor shown in FIG. 8. FIG. 12A shows a schematic of biotin-streptavidin binding recognition. FIG. 12B shows the amount of resonance red-shift resulting from device exposure to different solutions. Bar (A) shows the amount of red-shift resulting from specific binding of streptavidin to biotin. Bar (B) shows that the contribution to the shift from non-specific binding (no probe molecule) is negligible. Bar (C) shows that there is no contribution by the buffer alone.

FIG. 13 shows the corresponding transmission spectrum for the PhC of FIG. 1A. The transmission spectrum was measured using the setup illustrated in FIG. 4.

FIG. 14 illustrates the field profile calculation using the plane-wave expansion method on an 11×11 array with 32 grid points per supercell. From left to right: Eₓ, E_{y}, H_{z}.

FIGS. 15A-B illustrates the 3-D finite-different time domain (“FDTD”) calculations. FIG. 15A shows the top view of the device with one latex sphere (˜370 nm in diameter) captured inside the central defect of the microcavity of FIG. 1A. FIG. 15B shows the normalized transmission spectra of the PhC microcavity. Curve (a) was measured before capture, and curve (b) was measured after one latex sphere infiltrated the defect.

FIG. 16 illustrates the resonance red-shift versus particle diameter. In this calculation an assumption was made that a cylindrical particle with a diameter equal to the height, and the particle is attached to the defect sidewall along the Γ-M direction.

FIG. 17 illustrates that the resonance red-shift depends on the particle position along the Γ-M direction, defined as the distance between the defect hole center and the particle center. A particle closer to the defect wall will produce a larger shift. The dashed line indicates the red-shift introduced by the particle positioned at the edge of the defect.

FIG. 18 shows the normalized transmission spectra of the PhC microcavity of FIG. 1C following the capture of several latex spheres (˜100 nm in diameter) captured inside the ring-shaped central defect of the microcavity. Curve (a) was measured before capture, and curve (b) was measured after the latex spheres infiltrated the defect.

FIG. 19 is a graph illustrating the corresponding dispersion relation between Cavity A and Cavity B, which gives rise to nearly parallel defect states (band A and band B) with a separation Δωₖ.

FIG. 20 schematically illustrates one approach for the size-selective protein patterning via microgels. A photonic crystal biosensor is prepared with a defect larger than the surrounding periodic void areas, and chemically treated (for example, with glutaraldehyde) to provide a protein-reactive surface (step A). After introducing a solution of glutathione- or NTA-functionalized microgel particles loaded with a GST fusion (glutathione) or His₆-tagged (Ni—NTA) protein (step B), particles are only able to diffuse into the large defect (step C). Protein on the surface of the microgel particle then becomes covalently attached to the interior surface of the defect via the reaction of surface amines of the protein with aldehyde groups on the walls of the defect. Subsequent addition (step D) of an excess of glutathione (for GST fusions) or imidazole (for His₆-tagged proteins) causes a release of the protein from the surface of the microgel; a concomitant temperature increase to 37° C. (a temperature at which most proteins are completely stable) dramatically decreases the size of the microgel particle (step E) allowing it to diffuse away from the biosensor.

FIG. 21 illustrates one approach for the size-selective functionalization of dual-defect photonic crystal biosensor devices. The larger of the two particles will first be introduced to the dual-defect device (step A). After sufficient time has elapsed to allow it to diffuse in to the larger of the two defects (step B), unreacted particles will be washed away, and the smaller of the two particles (bearing the second probe molecule) will be added to the device (step C). As in the single-defect structure, addition of an excess of glutathione (for GST fusions) or imidazole (for His₆-tagged proteins) coupled with an increase in the temperature to 37° C. will release both proteins from the microgel particle surface, and cause a dramatic drop in particle size (step D).

### DETAILED DESCRIPTION OF THE INVENTION

The present invention relates to two-dimensional photonic crystal arrays and their use in biological sensor chips, including those in the form of microfluidic devices. Methods of making the two-dimensional photonic crystals and biological sensor chips are described herein, as are uses of these devices to detect biological targets in samples.

The two-dimensional photonic crystals are fabricated using electron-beam lithography in any suitable substrate material. The substrate material is preferably a semiconductor material formed over an insulator material. Exemplary semiconductor materials include, without limitation, p-doped (e.g., (CH₃)₂Zn, (C₂H₅)₂Zn, (C₂H₅)₂Be, (CH₃)₂Cd, (C₂H₅)₂Mg, B, Al, Ga, In) silicon, n-doped (e.g., H₂Se, H₂S, CH₃Sn, (C₂H₅)₃S, SiH₄, Si₂H₆, P, As, Sb) silicon, intrinsic or undoped silicon, alloys of these materials with, for example, germanium in amounts of up to about 10% by weight, mixtures of these materials, and semiconductor materials based on Group III element nitrides. Exemplary insulator materials include, without limitation, an oxide such as silicon oxide or air/solution interface.

Using electron-beam lithography, the two-dimensional photonic crystals can be prepared by forming a hexagonal array of cylindrical air holes in the substrate material (e.g., a 400 nm-thick silicon (Si) slab separated from the Si substrate by 1 μm of SiO₂) to provide a good vertical confinement for the propagation modes. The fundamental principles of photonic crystal design are described in Joannopoulos et al., In Photonic Crystals: Molding the Flow of Light, Princeton University Press, Princeton (1995), which is hereby incorporated by reference in its entirety. Most photonic crystals have a lattice constant a, which is the on-center distance between air holes; a hole diameter d; and a defect introduced at the center of the periods of air holes. The defect is introduced by either reducing or increasing the center pore diameter. Based on these properties, the photonic crystal is characterized by a corresponding resonance (at a particular wavelength) for TE-like modes. Two ridge waveguides, tapered to match the mode of the microcavity, are used to couple light in and out of the microcavity.

In preferred embodiments, the holes of the lattice array are uniformly spaced (according to the lattice constant).

In other embodiments, however, the holes of the lattice array can be randomly spaced or the spacing can be varied as a function of distance from the center defect.

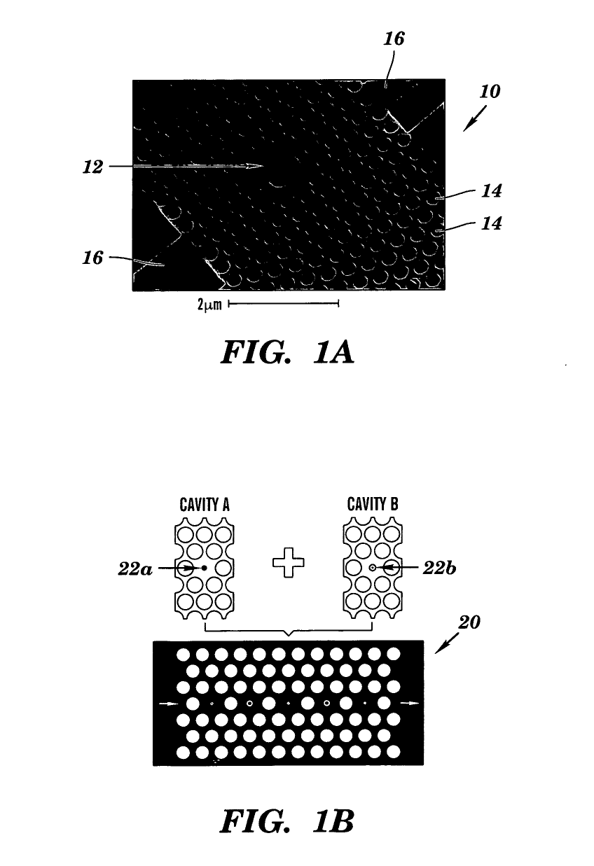

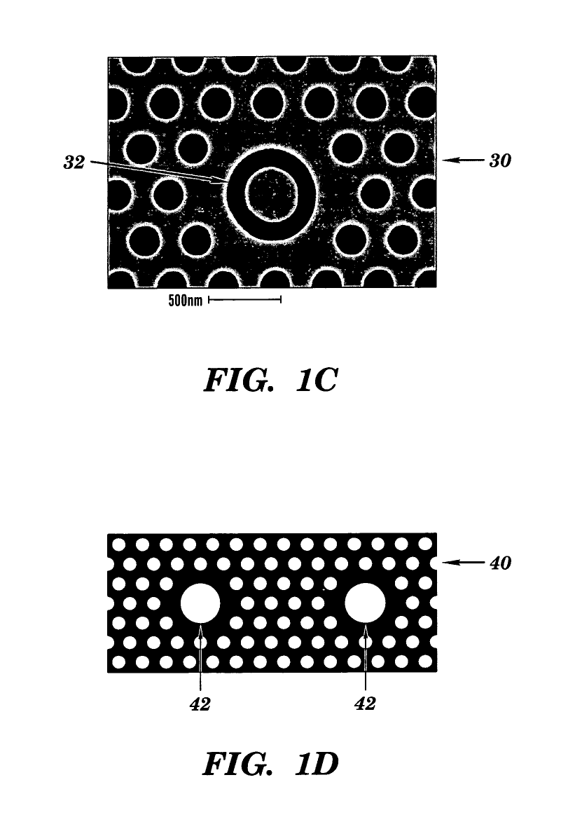

One embodiment of the photonic crystal 10 is illustrated in FIG. 1A. In this embodiment, the surface of the substrate has a lattice array of substantially aligned pores 14 and a central defect 12 formed in the lattice array, where the central defect is characterized by a radius that is about the distance of (a-d/2), or greater. In the arrangement shown in FIG. 1A, the central defect is larger than the lattice constant of the array, in which case the first period surrounding the center of the array is consumed by the defect. Two tapered ridge waveguides 16 are used to couple light in and out of the microcavity.

This embodiment is particularly well suited to allow for size selection of the target, and viruses are the ideal target. The central defect 12 can be configured in sub-micron range such that large (micron sized and greater) objects, such as most bacteria and eukaryotic cells, do not penetrate into the defect while virus particles are size matched to the defect. For example, the defects can be sized slightly larger than the target virus, preferably by about 5 nm to about 50 nm (or more) depending on the size and dimension of the probe and the surface chemistry involved. Thus, with appropriate probe molecules that bind specifically to the target virus, the defect can be tailored to a particular class of viruses or a specific strain. Exemplary viruses include, without limitation, the hepatitis virus (50 nm in diameter), influenza A (˜100 nm in diameter), HIV (˜120 nm in diameter), rhinovirus (˜22-30 nm in diameter), Rabies virus (˜130-390 nm by 50-95 nm, and bullet-shaped), and Vaccinia and Variola virus (˜300-450 nm by 170-260 nm, and brick shaped) (Koneman et al., Color Atlas and Textbook of Diagnostic Microbiology, Lippincott, (1997), which is hereby incorporated by reference in its entirety). Objects smaller than viruses (single proteins, single copies of nucleic acids) penetrate the defect but (even if nonspecifically bound) do not provide sufficient mass as to provide a shift as large as for capture of a virus-sized particle.

A second embodiment of the photonic crystal 20 is illustrated in FIG. 1B. In this embodiment, the surface of the substrate has a lattice array of substantially aligned pores and two or more central defects 22a, 22b formed in the lattice array. The two or more central defects are characterized by resonance modes at different wavelengths of light; in other words, the two or more defects are characterized by different sizes or different shapes (i.e., closed-loop structure as described below). As with the first embodiment, two tapered ridge waveguides are used to couple light in and out of the microcavity. In this embodiment, the central defects can be any size. In some embodiments they can be larger than the surrounding pores and in other embodiments they can be smaller than the surrounding pores, or one defect can be larger and the other smaller than the surrounding pores.

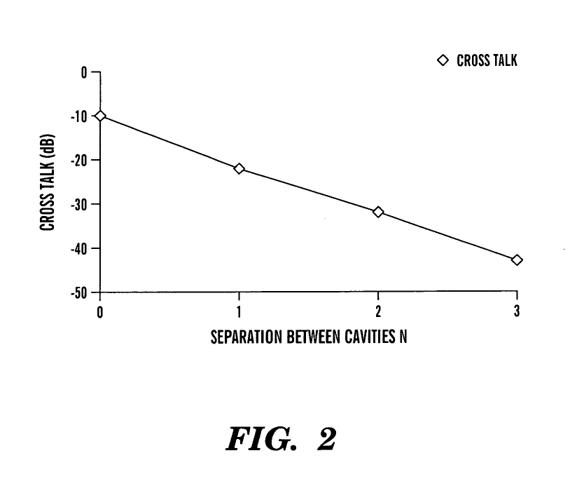

In this embodiment, the two or more central defects are shown uniformly spaced along the length of the light path (i.e., separated by one period). It should be appreciated, however, that the separation between defects can vary. Generally, the further apart the defects, the less cross-talk between the output modes, and the closer together the defects the more likely that cross-talk will occur between output modes. The crosstalk between the two cavities with distinction ratio M defined as:

$$M = \frac{Δ {λ}_{unf}}{Δ {λ}_{f}} {\vert}_{at K}$$

where Δλ_{f} indicates the resonance redshift obtained from targets captured in the cavity and Δλ_{unf} due to the targets captured in the neighboring cavities. As the separation between consecutive cavities enlarges, the coupling between the cavities reduces. FIG. 2 shows that as the number of the air holes between the successive cavities increases, ratio M will decrease almost linearly at a log scale.

This embodiment is particularly well suited for detecting multiple targets, with each differently sized defect being distinctly labeled with a probe. For example, with the case of influenza, it may be desirable to identify two different strains of the virus by using different probes specific for these different strains. Alternatively, two entirely unrelated targets can be probed (e.g., hepatitis and HIV).

A third embodiment of the photonic crystal 30 is illustrated in FIG. 1C. In this embodiment, the surface of the substrate has a lattice array of substantially aligned pores and a central defect 32 formed in the lattice array, where the central defect is shaped as a closed-loop structure. As shown, the closed-loop structure that forms the central defect 32 is ring-shaped; however, it should also be appreciated that the closed-loop structure can also take on other closed-loop shapes, such as an oval. Regardless of the closed-loop shape, the closed-loop is preferably characterized by a uniform dimension of the defect. As with the first embodiment, two tapered ridge waveguides are used to couple light in and out of the microcavity.

In this embodiment, the closed loop structure of the central defect is ring shaped and has an overall dimension that is greater than the diameter of the pores. Because the overall size of this defect is larger than the lattice constant of the array, the first period surrounding the center of the array is consumed by the defect.

A fourth embodiment of the photonic crystal 40 is illustrated in FIG. 1D. In this embodiment, the surface of the substrate has a lattice array of substantially aligned pores and two or more central defects 42 formed in the lattice array, where the central defects are the same size/shape and are characterized by a radius that is about the distance of (a-d/2), or greater. In the arrangement shown, the central defect is larger than the lattice constant of the array, in which case the first period surrounding the center of the array is consumed by the defect. As with the first embodiment, two tapered ridge waveguides are used to couple light in and out of the microcavity.

This embodiment is particularly well suited for determining an estimate of, for example, viral load in a sample. Using a plurality of defects, the defects can be similarly labeled for a single target, and the percentage of defects where the target is bound can be divided by the volume of sample tested to estimate viral load per unit of sample.

Having formed the photonic crystal array, the biosensor chip can be fabricated by coupling one or more probes to a surface of the substrate exposed to the central defect.

Any suitable probe molecule can be used, but the probe should bind specifically to its intended target molecule (or organism containing the target molecule). Exemplary probe molecules include, without limitation, peptides and polypeptides, oligonucleotides and nucleic acid molecules having secondary or tertiary structures, or small molecules.

Exemplary non-polymeric small molecules include, without limitation: biotin, avidin, peptido-mimetic compounds, and vancomycin. One class of peptido-mimetic compounds is disclosed in U.S. Pat. No. 6,562,782 to Miller et al, which is hereby incorporated herein by reference in its entirety. A preferred peptido-mimetic compound which binds to lipopolysaccharide is a tetratryptophan ter-cyclopentane as disclosed in the above-noted patent to Miller et al. Other peptidomimetic compounds can also be employed.

Exemplary polypeptides include, without limitation, antibodies and antibody binding fragments; polypeptide antibody mimics; receptors for cell surface molecules or fragments thereof; a lipopolysacchardide-binding polypeptide; a peptidoglycan-binding polypeptide; a carbohydrate-binding polypeptide; a phosphate-binding polypeptide; a nucleic acid-binding polypeptide; and polypeptides which bind organic warfare agents such as tabun, sarin, soman, GF, VX, mustard agents, botulinium toxin, Staphylococcus entertoxin B, and saitotoxin.

The antibody used for coupling to the surface of the photonic crystal can be a monoclonal antibody or mono-specific polyclonal antibody population. Suitable antibody fragments include, without limitation, Fab fragments, F(ab)2 fragments, Fab′ fragments, F(ab′)2 fragments, Fd fragments, Fd′ fragments, Fv fragments, single-chain antibodies (i.e., covalently linked variable heavy (V_{H}) and light (V_{L}) domains), single-domain antibodies (i.e., monomeric variable domains) (see, e.g., Holt et al., Trends in Biotechnology 21:484-490 (2003), which is hereby incorporated by reference in its entirety), and minibodies, e.g., 61-residue subdomains of the antibody heavy-chain variable domain (Pessi et al., “A designed metal-binding protein with a novel fold,” Nature, 362:367-369 (1993), which is hereby incorporated by reference in its entirety).

A number of antibody mimics are known in the art including, without limitation, those known as monobodies, which are derived from the tenth human fibronectin type III domain (¹⁰Fn3) (Koide et al., “The Fibronectin Type III Domain as a Scaffold for Novel Binding Proteins,” J. Mol. Biol. 284:1141-1151 (1998); Koide et al., “Probing Protein Conformational Changes in Living Cells by Using Designer Binding Proteins: Application to the Estrogen Receptor,” Proc. Natl Acad. Sci. USA 99:1253-1258 (2002), each of which is hereby incorporated by reference in its entirety); and those known as affibodies, which are derived from the stable alpha-helical bacterial receptor domain Z of staphylococcal protein A (Nord et al., “Binding Proteins Selected from Combinatorial Libraries of an alpha-helical Bacterial Receptor Domain,” Nature Biotechnol. 15(8):772-777 (1997), which is hereby incorporated by reference in its entirety). Variations in the antibody mimics can be created by substituting one or more domains of these polypeptides and then screening the modified monobodies or affibodies for selective binding activity.

Exemplary nucleic acid probes include single-stranded oligonucleotides, nucleic acid molecules with secondary structure such as molecular beacons, which bind to target nucleic acid molecules via Watson-Crick base pairing, and nucleic acid aptamers, which are characterized by second and tertiary folding to achieve binding specificity.

Oligonucleotide probes can by DNA, RNA, or modified (e.g., propynylated) oligonucleotides of the type disclosed in Barnes et al., J. Am. Chem. Soc. 123:4107-4118 (2001), and Barnes et al., J. Am. Chem. Soc. 123:9186-9187 (2001), each of which is hereby incorporated by reference in its entirety. The oligonucleotide probes can be any length which is suitable to provide specificity for the intended target. Typically, oligonucleotide probes which do not contain modified nucleotides will be at least about 12 to about 100 nucleotides in length. For oligonucleotides which contain modified bases, sugars, or backbones (e.g., PNA), oligonucleotides should be at least about 7 nucleotides in length, up to about 100 nucleotides.

Hairpin nucleic acid molecules suitable for use in the present invention include those prepared according to the procedures described in PCT Application Publ. No. WO 2005/104813 to Miller et al., which is hereby incorporated by reference in its entirety.

Nucleic acid aptamers include multivalent aptamers and bivalent aptamers. Methods of making bivalent and multivalent aptamers and their expression in multi-cellular organisms are described in U.S. Pat. No. 6,458,559 to Shi et al., which is hereby incorporated by reference in its entirety. A method for modular design and construction of multivalent nucleic acid aptamers, their expression, and methods of use are described in U.S. Patent Publication No. 2005/0282190, which is hereby incorporated by reference in its entirety.

Identifying suitable nucleic acid aptamers that bind specifically to a target molecule basically involves selecting aptamers that bind the target protein or nucleic acid molecule with sufficiently high affinity (e.g., K d=20-50 nM) and specificity from a pool of nucleic acids containing a random region of varying or predetermined length (Shi et al., “A Specific RNA Hairpin Loop Structure Binds the RNA Recognition Motifs of the Drosophila SR Protein B52,” Mol. Cell Biol. 17:1649-1657 (1997); Shi, “Perturbing Protein Function with RNA Aptamers” (thesis, Cornell University) microformed on (University Microfilms, Inc. 1997), each of which is hereby incorporated by reference in its entirety). This can be achieved using an established in vitro selection and amplification scheme known as SELEX. The SELEX scheme is described in detail in U.S. Pat. No. 5,270,163 to Gold et al.; Ellington and Szostak, “ In Vitro Selection of RNA Molecules that Bind Specific Ligands,” Nature 346:818-822 (1990); and Tuerk & Gold, “Systematic Evolution of Ligands by Exponential Enrichment: RNA Ligands to Bacteriophage T4 DNA Polymerase,” Science 249:505-510 (1990), each of which is hereby incorporated by reference in its entirety.

The coupling of probes to the surface of the photonic crystal can be achieved using well known binding chemistries for tethering protein- and nucleic acid-based probes to solid surfaces. Suitable binding chemistries are described, for example, in U.S. Pat. No. 7,226,733 to Chan et al., which is hereby incorporated by reference in its entirety.

Deposition of the probes on the photonic crystal array can be achieved according to any one of several embodiments.

According to one approach, the one or more probes are coupled to substantially the entire surface of the photonic crystal array, which includes the surfaces of the holes, the top surface of the array (i.e., the regions between holes), and the surface of the central defect. Devices functionalized according to this approach are capable of detecting a shift of ˜0.1 nm. Thus, the minimum amount of analyte that can be measured is ˜2.5 fg, if it is assumed that the bio-molecules form a uniform monolayer on the internal surface of all the pores.

According to another approach, the one or more probes are coupled to the substrate surface in the central defect. In one embodiment this includes both the sidewalls and bottom of the central defect, and in another embodiment this includes only the sidewalls of the central defect.

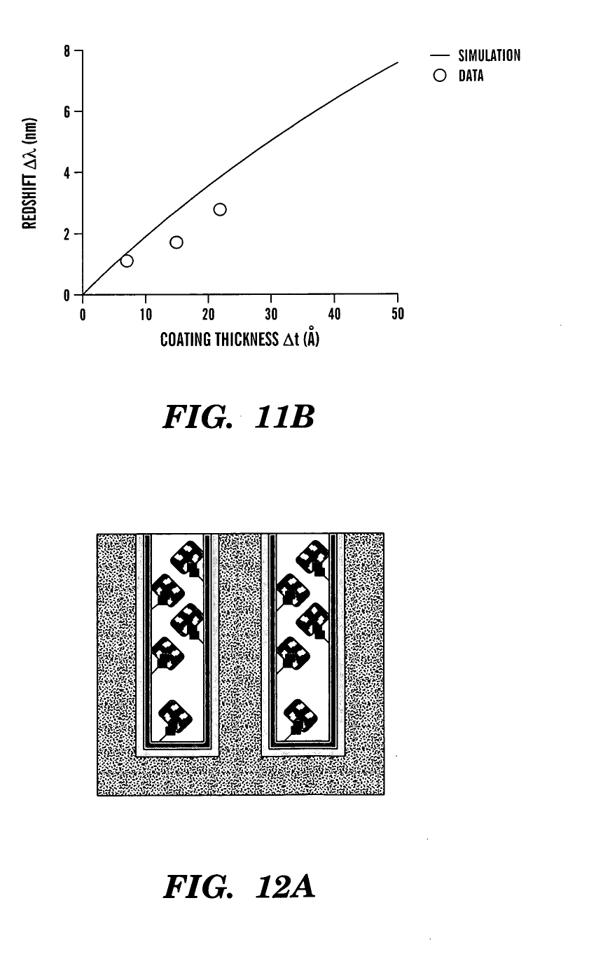

As shown in FIG. 11A, 3-D FDTD simulations show that the resonance red-shift increases almost linearly with the coating thickness. The red-shift is much larger when the molecules are attached on the pore walls, whereas the contribution of material on top of the device and at the bottom of the pores is negligible. This is expected because light is mainly confined within the PhC slab.

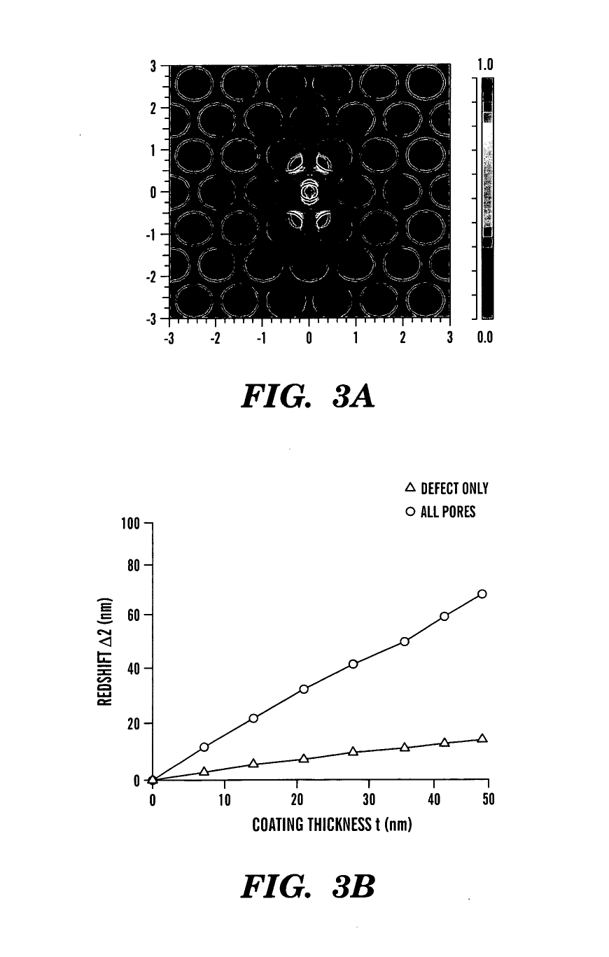

As shown in FIG. 3A, the electric field distribution is strongly localized in the defect, which is the most sensitive region to a refractive index change. Thus, the contribution of the defect region to the measured shift should be larger than that of the rest of the pores. FIG. 3B demonstrates this by comparing the calculated amount of red-shift due to the infiltration of biomolecules in all the pores versus that due to the infiltration only within the central defect. In the latter case, the sensitivity given by Δλ/Δt drops by a factor of 4. However, the total amount of biomolecules required decreases from ˜2.5 fg to ˜0.05 fg. This number supports the belief that the presence of a single bioparticle in the microcavity defect hole can be detected.

When the crystal array is structured with two or more defects (see FIGS. 1B and 1D), then different defects can be labeled with the same probe or with different probes. For example, a first probe that recognizes a first target can be bound to a surface of the substrate exposed to one central defect, and a second probe that recognizes a second target can be bound to a surface of the substrate exposed to a different central defect.

To achieve sensors with single particle sensitivity, the defects can be surface modified by confining the surface chemistry and reagents only to the central defect(s) that are to be functionalized with the one or more probes.

One approach to achieve this limited coupling of probes involves a size-based reagent transfer methodology using appropriately sized polymer nanospheres as the vehicles for delivery of probes into only the defects. This effectively converts the functionalization process into a simple “self assembly” process.

Polymer microgels have been studied for some time as novel materials because of their ability to respond to changes in temperature, pH, concentration of specific ions, and applied electrical or magnetic field (Das et al., “Microgels: Old Materials with New Applications,” Annu Rev. Mater. Res. 36:117-142 (2006), which is hereby incorporated by reference in its entirety). Gels produced by co-polymerization of acrylamide and bisacrylamide are particularly familiar to molecular biologists, since these are used extensively in carrying out biomolecular separations via gel electrophoresis.

Basically, the defect will be treated with an aminoalkyl trialkoxysilane, followed by glutaraldehyde, to provide an amino-reactive surface capable of binding proteins or amino-derivatized a nucleic acid probes. Alternatively, streptavidin-biotin/avidin can be used as coupling agents. Regardless, microparticles of an appropriate size, which are previously functionalized with the polypeptide or nucleic acid probe, are only able to diffuse into the large. Probe molecules on the surface of the microparticle become covalently attached to the interior surface of the defect via the reaction of amino groups of the protein or derivative nucleic acid with aldehyde groups on the walls of the defect. This process can optionally be enhanced by cooling the temperature of the system to about 15-22° C., which will cause the microgel bead to expand and make greater contact with the walls of the defect. Subsequent addition of an excess of glutathione (for GST fusions or amino-derived nucleic acids) or imidazole (for His₆-tagged proteins) causes a release of the protein or nucleic acid from the surface of the microgel particle. Upon increasing the temperature to 37° C., the size of the microgel particle dramatically decreases, which then allows the particle to diffuse away from the defect.

For structure containing two or more differently sized defects, both of which are larger than the surround pores, an analogous procedure can be employed with two different size microgel particles. The larger of the two (or more) particles, bearing a first probe, can be introduced to the device first, and after removing unreacted particles the smaller of the two (or more) particles, bearing a second probe, can be added to the device. Thereafter, the process is largely the same.

Where the defects are smaller than the surrounding pores, this same process can be used. In one approach, unlabeled microgel particles larger than the central defects can be introduced to the device first, filling in the pores, and thereafter labeled microgel particles can be introduced to label the smaller defects. In another approach, the unlabeled microgel particles can be replaced with a “falsely-labeled” microgel particle that loads the pores with an agent that is unreactive with the target molecule or otherwise renders the pore surface unreactive with proteins or nucleic acid molecules.

The latter approach can also be used as an intermediate step when defects larger than the pores and defects smaller than the pores are present in a single sensor device. The procedure for filling the largest opening first, and then proceeding to the next largest size opening, and so on, is maintained whether the opening to be filled is a defect to be labeled or a pore that is to remain unlabeled.

Yet another option involves coating the surface of the central defect with a layer of metal prior to coupling of the one or probes to the defect surface. Thus, in this embodiment, the probes are coupled to the layer of metal. Basically, the process described above can be used, but the binding chemistries may differ. The coupling of polypeptides and nucleic acids to metal such as gold, platinum, silver, and palladium are well known in the art. These devices will also be useful for detecting Raman scattering, which may be suitable for confirming the capture of a target molecule or to monitor single molecule (or particle) chemistry, as described below.

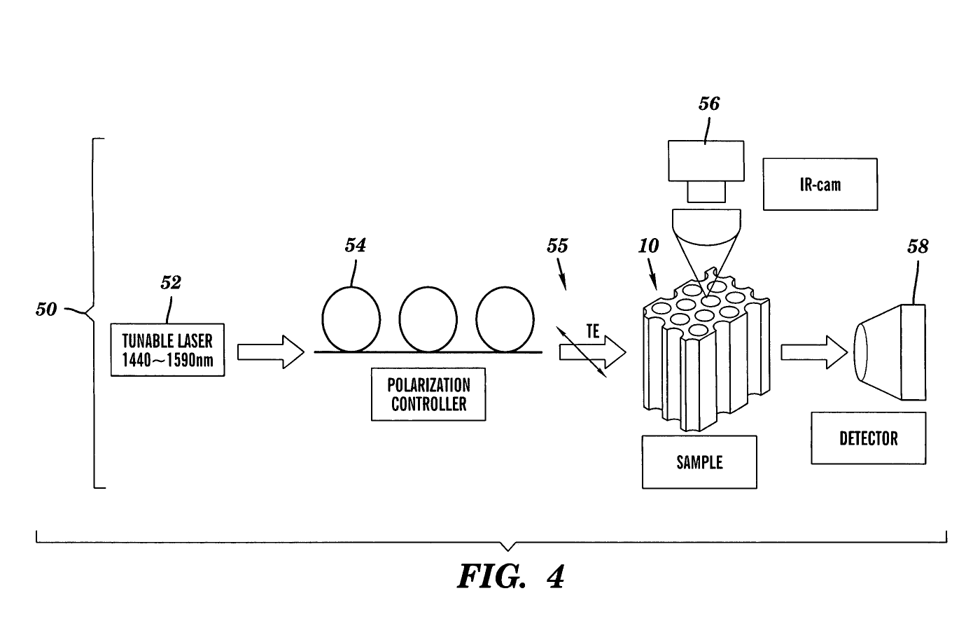

Referring now to FIG. 4, the biosensor chip of the present invention is intended to be incorporated into a sensor device 50. The sensor device 50 includes a light source 52, a polarization controller 54, and polarizer 55, which together deliver a polarized beam of light to the input optical waveguide of the 2-D photonic crystal 10. Light coupled out of the photonic crystal by the output waveguide is detectable by detector 58. An infrared camera 56 is optional, but it can be used to assist in alignment and for monitoring radiation losses.

The light source 52 can be any source of light, but preferably the light source 52 is a tunable, collimated, monochromatic light source. A variety of different types of light sources, such as a light-emitting diode, a laser, or a lamp with a narrow bandpass filter, can be used.

The polarization controller 54 is positioned in the path of the light from the light source 52 and polarizes the light in a single direction (TE polarization). Any of a variety of polarizers can be used to satisfactorily eliminate the TM-component of the light from the light source 52.

Suitable detectors include, without limitation, photodiodes, photomultiplier tubes, and charge-coupled detectors. A preferred detector is the type employed in the examples, namely an InGaAs detector with an N₂ cooling system that eliminates thermal noise.

This sensor device can also include two or more of the biosensor chips, with each of the biosensor chips being coupled to respective first and second optical waveguides, allowing multiple sensing chemistries to be observed simultaneously for the detection of multiple targets in one or more samples subject for testing.

According to a preferred embodiment of the present invention, the biosensor chip of the present invention is preferably integrated into a microfluidic device that delivers a flow of sample material over the photonic crystal, particularly the central defect thereof.

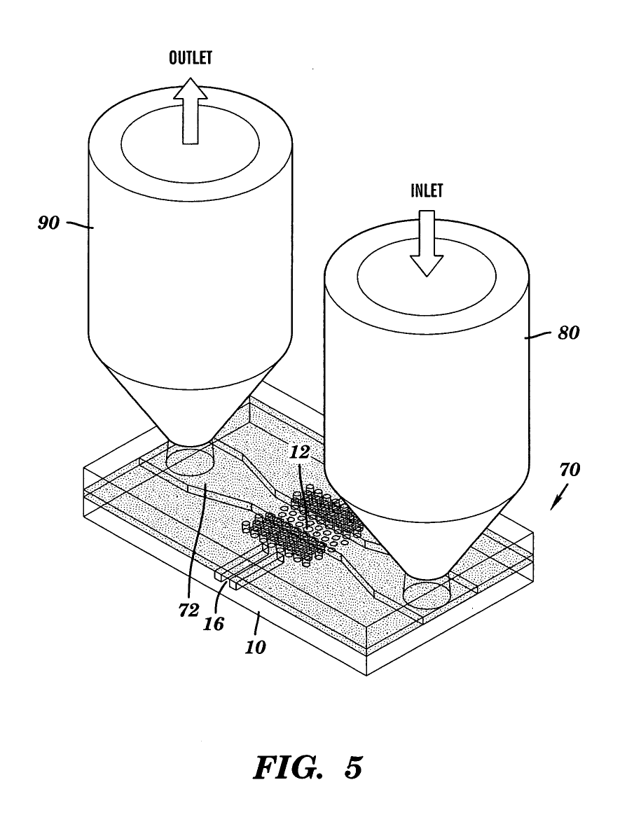

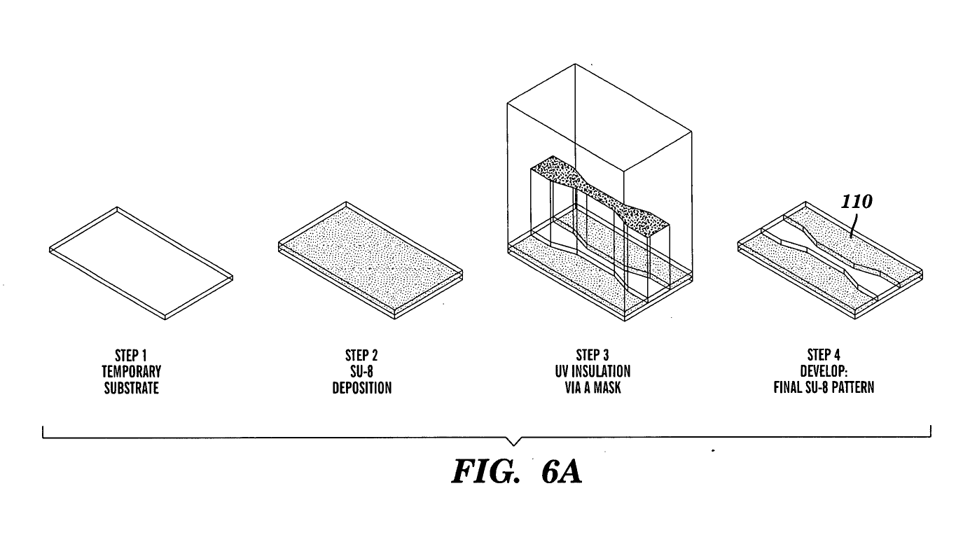

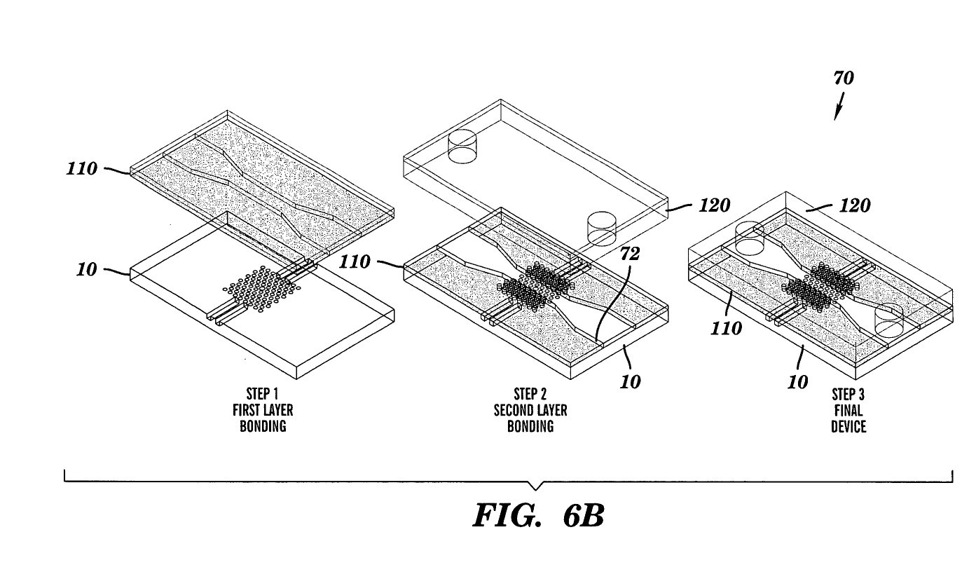

Referring now to FIG. 5, a microfluidic device 70 according to one embodiment of the present invention is illustrated. The microfluidic device 70 includes a delivery system having a fluid inlet 80 and a fluid outlet 90, and a channel 72 between the fluid inlet and fluid outlet that communicates with the photonic crystal surface. The device preferably includes a polymer layer 110 (see FIG. 6B) positioned against at least a portion of the surface of the substrate containing the photonic crystal array 10, whereby the polymer layer 110 and the substrate together define the passage 72. A cover 120 defines inlet and outlet ports in which the inlet 80 and outlet 90 are received. The inlet 80 and outlet 90 may optionally contain a filter membrane. The filter at the inlet 80 can be used to remove debris that might otherwise interfere with detection, and the filter at the outlet can be used to concentrate material larger than a particular size (e.g., viruses). One type of filter is a nanoporous nanoscale membrane of the type described in U.S. Patent Application Publ. No. US 2006/0278580 to Striemer et al., U.S. Patent Application Publ. No. US 2007/0231887 to Striemer et al., and Striemer et al., “Charge- and Size-based Separation of Macromolecules Using Ultrathin Silicon Membranes,” Nature 445:749-753 (2007), each of which is hereby incorporated by reference in its entirety.

Ideally, the material used to build the channels should be biocompatible, resistant to biofouling, and characterized by a small refractive index (which will confine the optical mode in the photonic structure). Finally, as the active surface area of the device is only a few μm², it should have a resolution that enables the structuring of small cross-sectional area channels (typically 2-3 μm width and 1-2 μm height). Several existing materials, widely used for the fabrication of fluidic channels, can address these three basic needs.

Two categories can be distinguished among them: those based on glasses, such as glass, Pyrex, quartz, etc. (Ymeti et al., “Integration of Microfluidics with a Four-channel Integrated Optical Young Interferometer Immunosensor,” Biosens. Bioelectron. 20:1417-1421 (2005), which is hereby incorporated by reference in its entirety); and those based on polymers such as polyimide, photoresist, SU-8 negative photoresist, polydimethylsiloxane (“PDMS”), and silicone elastomer PDMS (McDonald et al., “Fabrication of Microfluidic Systems in poly(dimethylsiloxane),” Electrophoresis 21:27-40 (2000), which is hereby incorporated by reference in its entirety), liquid crystal polymer, Teflon, etc. While the glass materials have great chemical and mechanical resiliency, their high cost and delicate processing make them less frequently used for this kind of application. In contrast, polymers have gained wide acceptance as the materials of choice for fluidics applications. Moreover, structuring technologies involved in their use, such as bonding, molding, embossing, melt processing, and imprinting technologies, are now well developed (Mijatovic et al., “Technologies for Nanofluidic Systems: Top-down vs. Bottom-up—A Review,” Lab on a Chip 5:492-500 (2005), which is hereby incorporated by reference in its entirety). An additional advantage of polymer-based microfluidic systems is that valves and pumps made with the same material are readily integrated (Unger et al., “Monolithic Microfabricated Valves and Pumps by Multilayer Soft Lithography,” Science 288:113-116 (2000), which is hereby incorporated by reference in its entirety).

PDMS and SU-8 resist are particularly well studied as raw materials for the construction of microfluidic systems. Both of them are optically transparent, and have refractive indices much lower than that of silicon. The refractive index of PDMS is about 1.4 (Horvath et al., “Fabrication of All-polymer Freestanding Waveguides,” J Micromechanics Microengineering 13:419-424 (2003), which is hereby incorporated by reference in its entirety), and the refractive index of SU-8 is about 1.6 (Borreman et al., “Fabrication of Polymeric Multimode Waveguides and Devices in SU-8 Photoresist Using Selective Polymerization,” Proceedings Symposium IEEE/LEOS Benelux Chapter, Amsterdam, pp. 83-86 (2002), which is hereby incorporated by reference in its entirety). Their mechanical and chemical comportment are strongly disparate: SU-8 is stiffer (Blanco et al., “Microfluidic-optical Integrated CMOS Compatible Devices for Label-free Biochemical Sensing,” J Micromechanics Microengineering 16:1006-1016 (2006), which is hereby incorporated by reference in its entirety) than PDMS, and so the structuring techniques of these two materials are different. PDMS is also subject to wall collapse, depending on the aspect ratios of the channels (Delamarche et al., “Stability of Molded polydimethylsiloxane,” Adv. Materials 9:741-746 (1997), which is hereby incorporated by reference in its entirety). Their chemical properties are an important aspect for the wanted application. They both have a hydrophobic surface after polymerization, which can lead to an attachment of the proteins onto the PDMS walls, and can fill the channel in case of small cross-section. Both the surface of PDMS and of SU-8 can be treated with a surfactant or by plasma to become hydrophilic (Nordstrom et al., “Rendering SU-8 Hydrophilic to Facilitate use in Micro Channel Fabrication,” J Micromechanics Microengineering 14:1614-1617 (2004), which is hereby incorporated by reference in its entirety). The composition of SU-8 can also be modified before its structuring to become hydrophilic after polymerization (Chen and Lee, “A Bonding Technique using Hydrophilic SU-8,” J Micromechanics Microengineering 17:1978-1984 (2007), which is hereby incorporated by reference in its entirety). Fouling of the channel surface via nonspecific binding is an obvious concern for any microfluidic application. Anecdotal evidence suggests that SU-8 is less prone to this, but it is important to note that chemical treatment methods are also available for improving the performance of PDMS (Lee and Vörös, “An Aqueous-based Surface Modification of poly(dimethylsiloxane) with poly(ethylene glycol) to Prevent Biofouling,” Langmuir 21:11957-11962 (2004), which is hereby incorporated by reference in its entirety).

Referring now to FIGS. 6A-B, an adhesive bonding and release etching technology can be used to fabricate the microfluidic device 70 (Agirregabiria et al., “Fabrication of SU-8 Multilayer Microstructures Based on Successive CMOS Compatible Adhesive Bonding and Releasing Steps,” Lab on a Chip 5:545-552 (2005), which is hereby incorporated by reference in its entirety). As shown schematically in FIG. 6A-B, the overall process includes the following steps: 1) providing a substrate; 2) a sacrificial layer of LOR (Lift-Off Resist) is deposited into a temporary substrate, e.g., Pyrex; 3) the substrate is coated with the photoresist SU-8 and the SU-8 photoresist is patterned via UV broad band insulation; 4) the patterned SU-8 layer is bonded onto the substrate of the photonic crystal device 10 via thermal compression bonding methods or other suitable means; 5) the temporary Pyrex substrate is released by dissolution of the sacrificial layer (not shown); and 6) the process is repeated a second time for bonding of the channel cover 120. The fluidics inlet and outlet ports, typically on the order of 500 micron diameter, are patterned on this cover layer 120. If a positive resist is used for the fabrication of the photonic crystal, an initial planarization step of the photonic crystal surface should be performed to ensure a fluid-tight seal between the surface of the photonic crystal 10 and the layer 110.

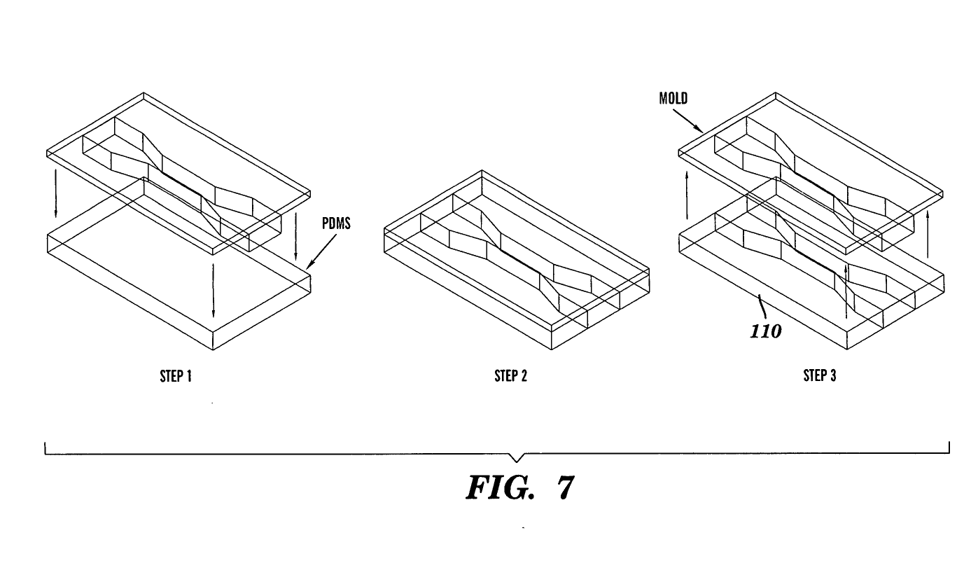

PDMS channels can be realized using the widely employed technology of soft lithography (McDonald et al., “Fabrication of Microfluidic Systems in poly(dimethylsiloxane),” Electrophoresis 21:27-40 (2000); Unger et al., “Monolithic Microfabricated Valves and Pumps by Multilayer Soft Lithography,” Science 288:113-116 (2000), each of which is hereby incorporated by reference in its entirety). As shown schematically in FIG. 7, the overall process includes the following steps: 1) a negative mold of the channel is produced, for example using a silicon substrate (produced using the same methodology as for fabrication of the photonic crystal device) (not shown); 2) the silicon elastomer is then cast using this mold (forming layer 110), peeled off, and bonded onto the substrate of the photonic crystal device 10 via thermal curable adhesion with oxygen plasma treatment or other suitable means; 3) another mold is realized for forming the cover layer 120 (see FIG. 6B), which includes fluidics inlet and outlet ports patterned on this second mold; and 4) finally, the silicon elastomer forming layer 120 is then cast onto this second mold, peeled off, and similarly bonded onto the first (channel-forming) PDMS layer 110.

The dimensions of the 2DPBG sensors place constraints on the fluidics system that are important to address. It is well known that the flow rate, Q (μliter/min), is proportional to the hydraulic diameter of the channel, D, raised to the 4^{th} power (Erickson et al., “Integration of Sub-wavelength Nanofluidics with Photonic Crystals,” Proceedings of International Mechanical Engineering Congress and Exposition ASME 1-8 (2005), which is hereby incorporated by reference in its entirety):

$$Q = {D}^{4} \frac{Δ P}{L}$$

Where ΔP is the applied pressure, L is the length of the channel, and D can be approximated to the height of the channel. This means that although flow rates of 50 nanoliters/min to 1 μliter/min can be reached in a 40 μm channel (Carlier et al., “Integrated microfluidics based on multi-layered SU-8 for mass spectrometry analysis,” J Micromechanics Microengineering 14:619-624 (2004), which is hereby incorporated by reference in its entirety), a 3 μm channel in the microfluidic device of the present invention would support flow rates on the order of 1 to 25 picoliters/minute (60 picoliters to 1.5 nanoliters/per hour).

To improve the sampling efficiency, a volume reduction/sample concentration stage can be used. This can be achieved by pre-filtering (Long et al., “Integration of Nanoporous Membranes for Sample Filtration/Preconcentration in Microchip Electrophoresis,” Electrophoresis 27:4927-4934 (2006), which is hereby incorporated by reference in its entirety) based on size or charge exclusion. The ultra-thin nanoporous silicon membranes as described above (U.S. Patent Application Publ. No. US 2006/0278580 to Striemer et al., and U.S. Patent Application Publ. No. US 2007/0231887 to Striemer et al.; Striemer et al., “Charge- and Size-based Separation of Macromolecules Using Ultrathin Silicon Membranes,” Nature 445:749-753 (2007), each of which is hereby incorporated by reference in its entirety) afford both size and charge-based separation capability. As described by Striemer et al., by varying fabrication parameters, pore diameters from 5 to 100 nm are readily achievable on membrane thicknesses of 5-20 nm.

Having formed a biological sensor device of the present invention, the device can be used to identify the presence of a biological target in a fluid sample. The biological target is detected by exposing the sensor device to a sample containing a biological target, and detecting a property of light emitted from the second waveguide, whereby detecting of the property indicates presence of the biological target in the sample.

Target molecules that can be bound be the one or more probes include, without limitation: proteins (including without limitation enzymes, antibodies or fragments thereof), glycoproteins, peptidoglycans, carbohydrates, lipoproteins, a lipoteichoic acid, lipid A, phosphates, nucleic acids which are expressed by certain pathogens (e.g., bacteria, viruses, multicellular fungi, yeasts, protozoans, multicellular parasites, etc.), or organic compounds such as naturally occurring toxins or organic warfare agents, etc., and whole virion or bacterium. These target molecules can be detected from any source, including food samples, water samples, homogenized tissue from organisms, etc. Moreover, the biological sensor of the present invention can also be used effectively to detect multiple layers of biomolecular interactions, termed “cascade sensing.” Thus, a target, once bound, becomes a probe for a secondary target. This can involve detection of small molecule recognition events that take place relatively far from the semiconductor structure's surface.

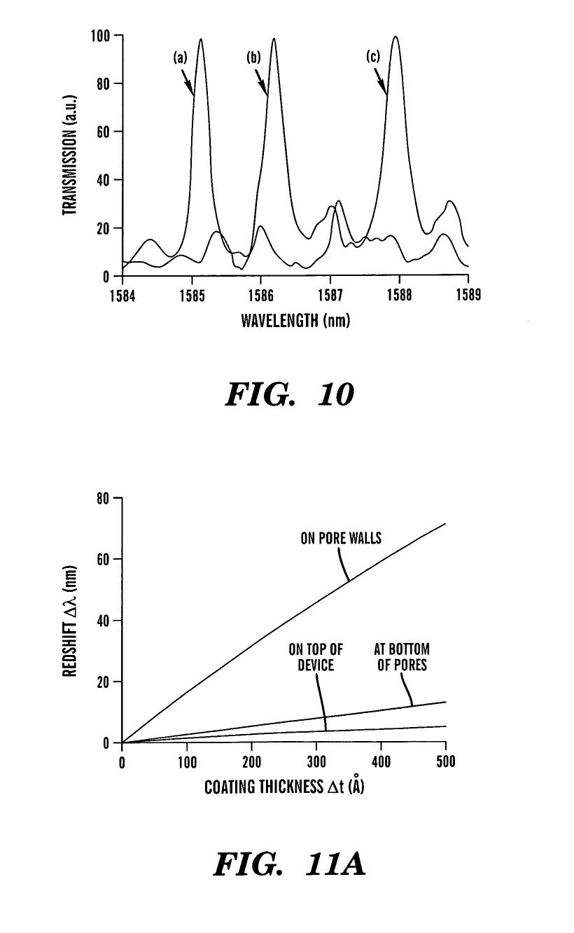

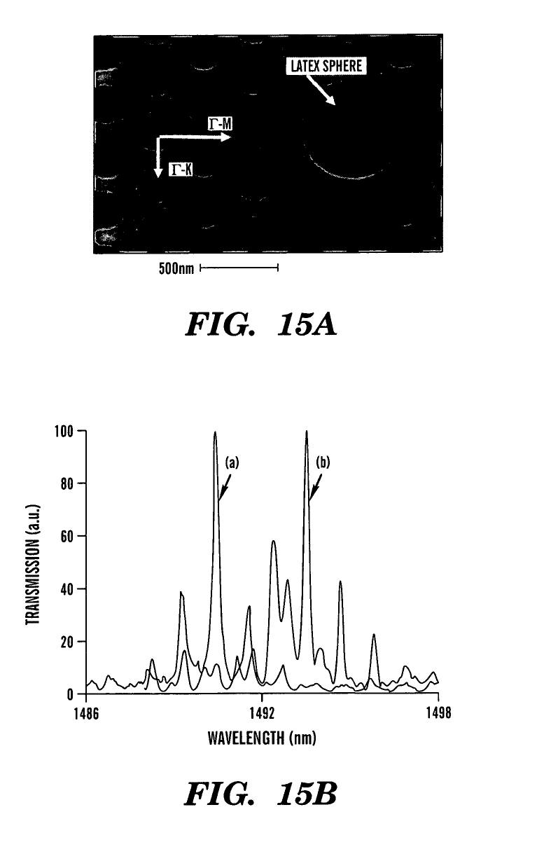

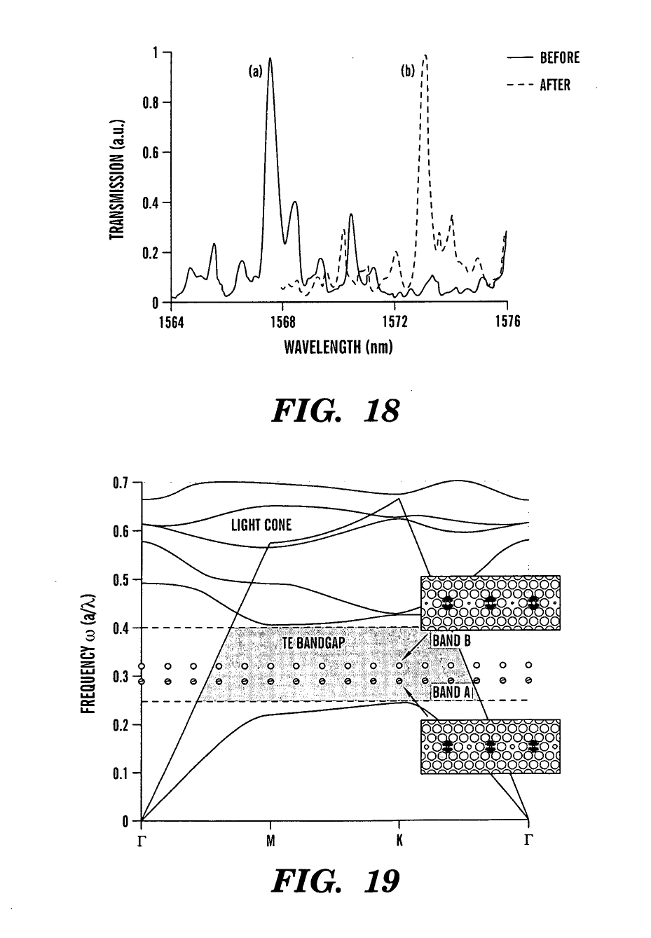

Regardless of the target being detected, the property of light emitted from the second waveguide that is detected can be a change in the refractive index of the biosensor chip. This is detectable by a resonance wavelength shift of light transmitted through the photonic crystal. When the refractive index of the central defect changes upon target binding, the output spectrum red-shifts (see FIG. 10, comparison of curves (b) and (c); FIG. 15B, FIG. 18). A red-shift occurs because the defect is filled with a material of larger refractive index. This is one of the major advantages of using silicon based photonic crystal structures for sensor applications. This is particularly useful when non-quantitative detection is desired.

One approach for detecting the presence of the biological target involves taking two measurements, one before exposure and one after exposure, and then comparing the results to identify the resonance wavelength shift. If the target is not detected, then the spectral curves (before and after) should overlap. If the target is bound, then the spectral curves (before and after) will red-shift and in a comparison of the curves the red-shifted peak will be evident (see FIG. 10, comparison of curves (b) and (c); FIG. 15B, FIG. 18).

Alternatively, knowing a priori the resonance wavelength shift expected in the presence of the biological target, the detector can be read as a “turn on” or “turn off” sensor device. For example, in FIG. 15B, by looking at only the spectrum in the 1493-1495 nm range, the absence of the target can be observed by the absence of a spectral peak in this band (at ˜1494 nm). Likewise, the presence of the target can be observed by the presence of a spectral peak in this band. Conversely, by looking at only the spectrum in the 1489-1491 nm range, the absence of the target can be observed by the presence of a spectral peak in this band (at ˜1490 nm) and the presence of the target can be observed by the absence of a spectral peak in this band. The “turn on” system, described first, is preferable to the latter-described “turn off” system.

In addition to detection via specificity of the probe, any Raman scattering of light emitted from the biosensor chip can be detected with this method. In this embodiment, the pores of the lattice array are coated on their internal surface with a layer of metal, which can be gold, silver, platinum, or palladium, and the layer of metal is less than about 1 μm thick, preferably less than about 100 nm thick. Raman scattering confirms the identity of the biological target by matching a spectral fingerprint for the desired target.

When quantitative detection is desired, the size of the photoluminescent peak emission shift correlates with the amount of bound target molecule which appears in the pores following exposure thereof to a sample containing the target molecule. Knowing the maximal amount of target molecule which can bind to a biological sensor of the present invention, i.e., the number of available target-binding groups on the surface-bound probes and the maximal shift which can be achieved under those conditions, it is possible to predict a quantitative concentration of the target molecule in a sample based on the detected shift which occurs.

### EXAMPLES

The Examples set forth below are for illustrative purposes only and are not intended to limit, in any way, the scope of the present invention.

### Example 1

### Fabrication of Two-Dimensional Photonic Crystal and Microcavity Biosensor Setup

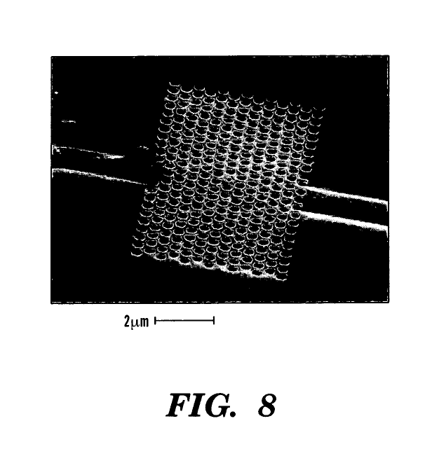

The structure depicted in FIG. 8 contains a hexagonal array of cylindrical air pores in a 400 nm-thick silicon (Si) slab separated from the Si substrate by 1 μm of SiO₂ to provide a good vertical confinement for the propagation modes. The photonic crystal has a lattice constant a of 465 nm and a pore diameter d of 270 nm. The defect was introduced by reducing the center pore diameter to 140 nm. Such a configuration gives rise to a resonance in the bandgap close to 1.58 μm for even (TE-like) modes. Here, TE-like mode was studied because there is no bandgap for TM-like modes beneath the light cone. Two tapered ridge waveguides were used to couple light in and out of the microcavity. They were tapered from 2 mm down to ˜0.7 μm to match the mode of the microcavity. Light is coupled along the Γ-M direction, because the resonance mode in-plane leakage is mainly in the Γ-M direction and, hence, the coupling efficiency is higher along this direction (Painter et al., “Defect Modes of a Two-Dimensional Photonic Crystal in an Optically Thin Dielectric Slab,” J. Opt. Am. B 16:275-285 (1999), which is hereby incorporated by reference in its entirety). The device was patterned using electron beam lithography.

Using the experimental setup shown in FIG. 4, a laser source tunable from 1440 nm to 1590 nm was used. TE polarized light was coupled to a polarization-maintaining tapered lensed fiber and then focused onto the input ridge waveguide. The transmitted signal was coupled out in a similar fashion, and measured using an InGaAs detector. To optimize the readout signal to noise ratio, a polarizer controller and a TE polarizer were used before the input and output end, respectively. An infrared camera was also used for alignment and monitoring scattering losses.

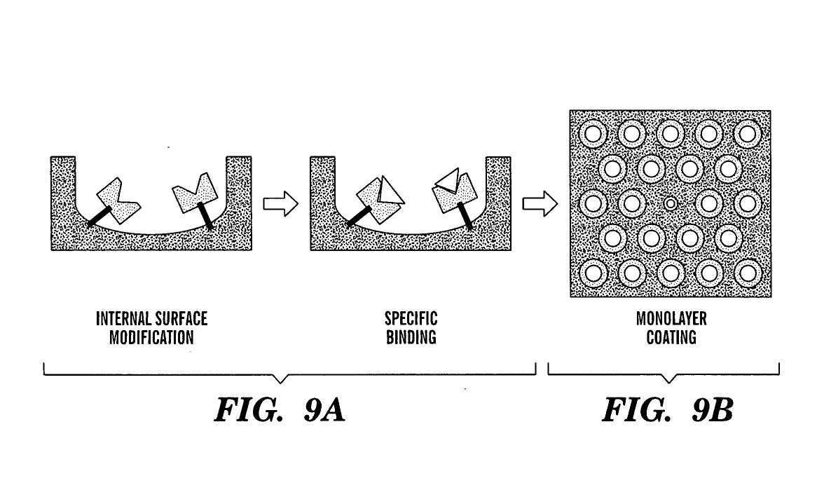

FIG. 9A illustrates the bio-molecule binding mechanism. Highly selective probe molecules (ex. DNA, antibody) are immobilized on the internal surface where they form a monolayer and capture the target molecules (e.g., DNA, protein). When a probe-functionalized sensor is exposed to the target, a monolayer of target species is again captured on the surface of the sensor. The bio-molecule coating causes a refractive index change in the vicinity of the pore wall, as shown schematically in FIG. 9B.

### Example 2

### Sensor Performance Characterization for Binding of Bovine Serum Albumin Using Glutaraldehyde Probe

To characterize the sensor performance, glutaraldehyde-bovine serum albumin (BSA) binding was used as the model system because glutaraldehyde has a strong affinity for BSA. The pore size of the device is ˜30 times larger than the protein hydrodynamic diameter (Kuntz et al., “Hydration of Proteins and Polypeptides,” Adv. Protein Chem. 28:239-345 (1974); Squire et al., “Hydrodynamic Properties of Bovine Serum Albumin Monomer and Dimer,” J. Biochem. 7:4261-4272 (1968), each of which is hereby incorporated by reference in its entirety), which guarantees a high infiltration efficiency of the proteins into the device and facilitates the uniform formation of a monolayer-thick coating on the pore walls.

To prepare the surface for the capture of BSA proteins, the device was first thermally oxidized at 800 to form a silica-like internal surface. The sensor was then treated with 2% amino-propyltrimethoxy-silane to create amino groups on the internal oxide surface, at which point the device was ready for bio-molecule recognition. The transmission spectrum was first measured after oxidation and silanization. Then a micro-pipette was used to apply a 2 μl droplet of 2.5% glutaraldehyde (the probe molecule) on the device. After waiting for a sufficient duration (30-60 min) to allow the proteins to immobilize on the pore walls, the device was rinsed with de-ionized water and the transmission spectrum was measured again. In the end, 2 μl of 2% BSA (the target molecule) was applied. 30 mins elapsed until the two proteins attach completely, and then the device was again rinsed to remove residual BSA. The transmission spectrum was again measured.

The raw data exhibit Fabry-Perot resonances due to reflection at the waveguide facets and PhC edges. These Fabry-Perot resonances are filtered out after performing a fast Fourier transform. FIG. 10 shows the smoothed transmission spectra near the microcavity resonance measured at three different binding stages. Curve (a) shows the initial transmission spectrum after oxidation and silanization. Curve (b) was measured after exposure to glutaraldehyde. A resonance red-shift of 1.1 nm was observed. Curve (c) shows a red-shift of 1.7 nm after BSA binding, thus a total shift of 2.8 nm compared with the initial spectrum.

To model the experimental results, calculations using a FDTD method and a plane-wave expansion with 32 grid points per supercell were performed. In the simulation, the refractive index of the dehydrated proteins was set as 1.45, which is consistent with the literature values (Ouyang et al., “Quantitative Analysis of the Sensitivity of Porous Silicon Optical Biosensors,” Appl. Phys. Lett. 88:163108 (2006), which is hereby incorporated by reference in its entirety) and also agrees with an independent ellipsometric measurement performed on a flat oxidized silicon wafer.

In the PhC biosensor, the molecules can form a layer everywhere: on the pore walls, at the bottom of the device, and on top of the device. 3-D FDTD simulations show that the resonance red-shift increases almost linearly with the coating thickness (FIG. 11A). The red-shift is much larger when the molecules are attached on the pore walls (upper curve), whereas the contribution of material on top of the device (lower curve) and at the bottom of the pores (middle curve) is negligible (FIG. 11A). This is expected, because light is mainly confined within the PhC slab. By comparing the simulation curve with the experimental shifts shown in FIG. 10, the layers of dehydrated glutaraldehyde and BSA molecules should be 7Å and 10Å thick, respectively.

To verify this, the same experimental protocol was applied on a flat oxidized silica wafer and the protein thickness was measured using ellipsometry. A thickness of 7±1 Å and 15±5 Å was measured for these two proteins. As shown in FIG. 11B, the ellipsometric data are in general agreement with the model, albeit with a slightly lower resonance shift than predicted. That may result from either an incomplete surface coverage by BSA or an over estimation of the thickness of a BSA monolayer from the preliminary ellipsometric measurement.

The PhC microcavity is an 11 (in Γ-M) by 21 (in Γ-K) array that has an internal pore wall surface area of ˜50 μm². The present device is capable of detecting a shift of ˜0.1 nm. Thus, the minimum amount of analyte that can be measured is 2.5 fg assuming that the bio-molecules form a uniform monolayer on the internal surface of all the pores. The amount of analyte detected is significantly reduced compared to SPR, which requires a relatively larger sensing area (from 0.01 mm² to 1 mm² (Kanda et al., “Label-Free Reading of Microarray-Based Immunoassays with Surface Plasmon Resonance Imaging,” Anal. Chem. 76:7257-7262 (2004); Nedelkov et al., “Surface Plasmon Resonance-Enabled Mass Spectrometry Arrays,” Electrophoresis 27:3671 (2006), each of which is hereby incorporated by reference in their entirety). The performance can be further improved by optimizing the quality factor Q.

As shown in FIG. 3A, the electric field distribution is strongly localized in the defect which is the most sensitive region to a refractive index change. Thus, the contribution of the defect region should be larger than the rest of the pores. FIG. 3B demonstrates this by comparing the calculated amount of red-shift due to the infiltration of bio-molecules in all the pores (upper curve) and that due to the infiltration only within the central defect (lower curve). In the latter case, the sensitivity given by Δλ/Δt drops by a factor of 4, however, the total amount of bio-molecules required decreases from 2.5 fg to 0.05 fg. FIG. 3A also shows that the electromagnetic field strength in neighboring pores is not completely negligible. If the area covered by the bio-molecules from the central defect to surrounding pores located in increasingly large concentric circles is increased, the sensitivity first increases but then saturates very rapidly. The figure inset plots the sensitivity, normalized to its maximum value obtained by coating uniformly in all the pores, versus the percentage of the total surface area that is covered by the bio-molecules.

### Example 3

### Sensor Sensitivity for Binding of Streptavidin Using Biotin Probe

Two important benchmarks for a biosensor are sensitivity and selectivity. Previous experiments demonstrated the capability of detecting the dehydrated protein layer thickness as thin as 1 Å. However, glutaraldehyde-BSA binding is a non-specific binding process; thus, it only shows the presence of bio-molecules inside the microcavity without specifying the type of proteins.

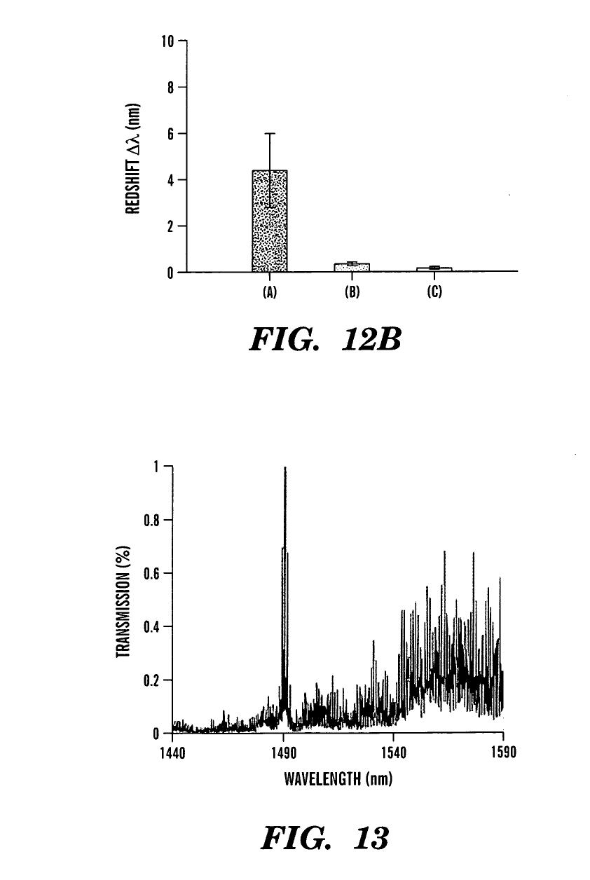

To demonstrate the selectivity of this device, biotin-streptavidin coupling was used as a model system. First the device was functionalized with the probe molecule (Sulfo-NHS-LC-LC-Biotin), which has an extremely high binding affinity for the target molecule (Streptavidin). Each streptavidin molecule has four equivalent sites for biotin which makes it an excellent molecular linker in many assays. As shown in FIG. 12A, the target molecules were immobilized on the pore walls in the presence of the probe molecules. The experimental results shown in FIG. 12B demonstrate the selectivity of this biosensing platform as well as its ability to avoid false positive signals. Bar (A) shows that the specific binding of streptavidin to biotin introduces a ˜4 nm red-shift. Bar (B) shows that the contribution to the resonance shift from non-specific binding (no probe molecule) is negligible. Bar (C) shows that there is no contribution from the buffer alone.

### Example 4

### Two-Dimensional Modification of the PhC Microactivity

The PhC structure depicted in FIG. 1A was patterned using electron beam lithography on a silicon-on-insulator wafer with a Si slab thickness of 400 nm. The PhC contains a hexagonal array with a lattice constant a of 400 nm and a pore diameter d of 240 nm. The defect was introduced by increasing the center pore diameter to 685 nm. The parameters were selected so that the resonant wavelength λ falls within the tuning range of our laser (HP Agilent 8618F, tunable from 1440 to 1590 nm). Here the TE-like mode was studied because there is no bandgap for TM-like modes beneath the light cone. The experimental setup (FIG. 4) was the same as that used in Example 1.

To study the spectral response to the capture of a single particle, the microcavity was designed with a central defect that is approximately three times larger than the surrounding holes. Thus, a particle with a diameter larger than that of the surrounding holes can be trapped in the defect but will stay on top of the surrounding holes, where it produces a negligible spectral shift (see Examples 2 and 3, supra). Such a configuration gives rise to a resonance in the bandgap close to 1.49 μm for even (TE-like) modes (FIG. 13) with a quality factor Q of ˜2000, in agreement with simulations based on both 3-D finite-difference time domain (FDTD) and plane-wave expansion methods.

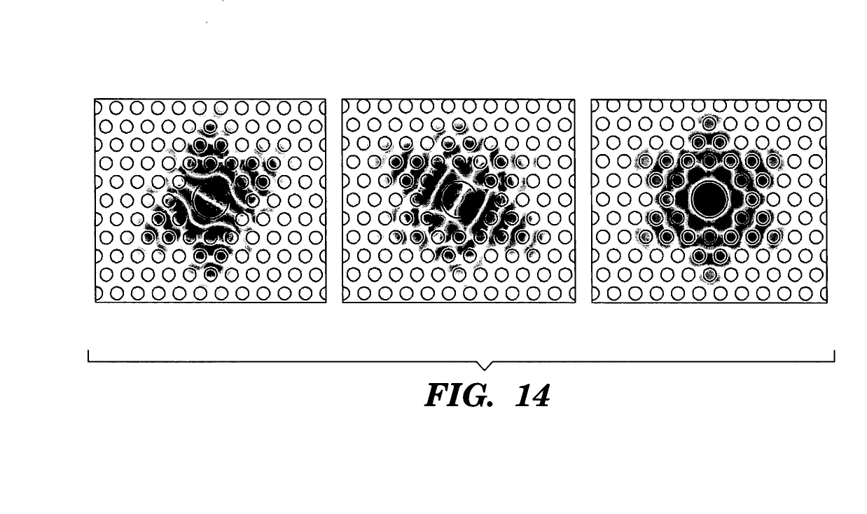

The electric-field distribution and the magnetic-field distribution are both shown in FIG. 14. Although the electric field is not as localized in a large defect hole as it is in a small defect hole (compare FIG. 3A), the field concentration is still large enough to make the device very sensitive to a small refractive index change inside the defect hole (Srinivasan et al., “Fourier Space Design of High-Q Cavities in Standard and Compressed Hexagonal Lattice Photonic Crystals,” Opt. Express 11:579 (2003), which is hereby incorporated by reference in its entirety).

To assess the sensitivity of the PhC, 370 nm latex spheres suspended in solution were exposed to the PhC and then the PhC was dried. In FIG. 15A, one latex sphere with a diameter of 370 nm and a refractive index ˜1.45 is shown captured inside the microcavity. In FIG. 15B, the spectrum labeled (a) shows the transmission spectrum before capture, and the spectrum labeled (b) was measured after capture of one latex sphere. The resonance red-shifts by approximately 4 nm. These measurements were carried out after the PhC device was dried.

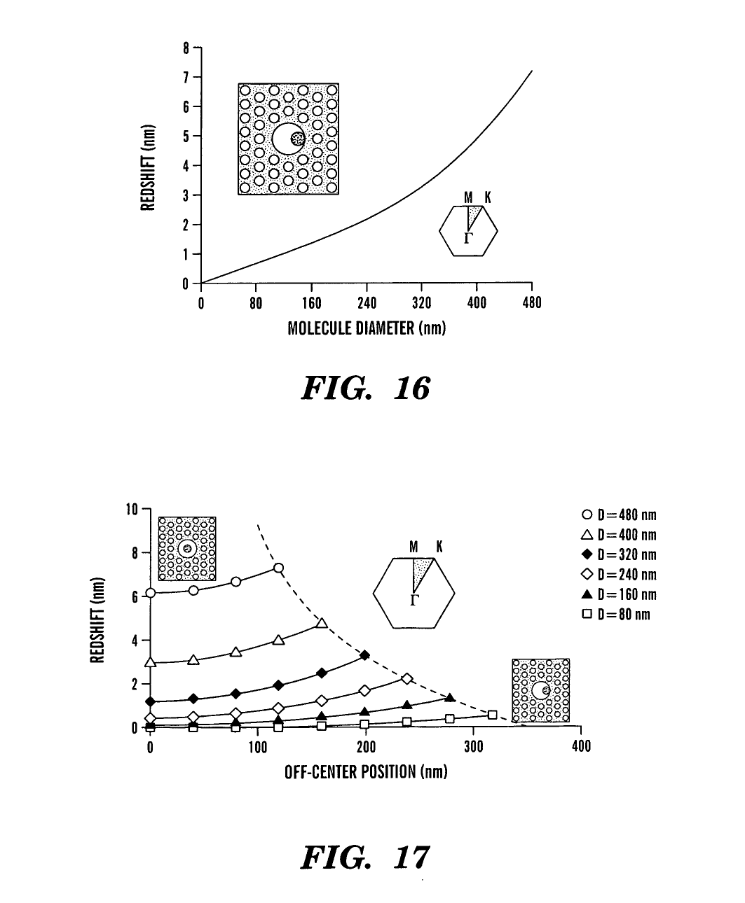

To verify the experimental results, 3-D FDTD calculations were performed assuming that the captured object is a cylinder with a height equal to its diameter and is attached to the defect sidewall along the Γ-M direction as indicated in the FIG. 12A. FIG. 16 shows that the resonance red-shift Δλ increases as the latex sphere diameter increases. A particle that has a diameter of 370 nm introduces a red-shift of 4.2 nm.

The measured shift shows good agreement with the simulations. However, in biosensing applications the entire defect internal surface is functionalized with probes (e.g., antibodies), thus, the target virus can be immobilized at the defect center or in the vicinity of the sidewall. The sensitivity of the spectral shift to particle position was studied with the 3-D FDTD method as shown in FIG. 17. As the particle is captured closer to the edge of the defect along the Γ-M direction, the resonance red-shift Δλ increases. A particle with a diameter of 370 nm introduces a red-shift Δλ of ˜2 nm if it is captured at the center of the defect and Δλ of ˜4 nm if it is captured at the edge. This can be explained from the electromagnetic field distribution shown in FIG. 14. The electric field is concentrated close to the edge of the central hole, which makes this region more sensitive to a refractive index change than the center of the hole. The guided TE-like mode is strongly confined inside the PhC slab, so that the overlap of the field with the particle is maximized at the slab center and decreases towards the bottom/top. Thus, the device sensitivity depends not only on the in-plane position as shown in FIG. 17, but also the vertical capture site. FDTD simulations show that a particle with 50 nm in diameter can introduce a red-shift of ˜0.41 nm when it is attached to the sidewall at the center and of ˜0.2 nm at the bottom of the defect.

### Example 5

### Two-Dimensional Modification of the PhC Microactivity

The PhC structure depicted in FIG. 1C was patterned using electron beam lithography on a silicon-on-insulator wafer with a Si slab thickness of 400 nm. The PhC contains a hexagonal array with a lattice constant, a, of 370 nm and a pore diameter, d, of 215 nm. The defect was introduced by forming a ring-shaped center pore having an outer diameter of 636 nm and an inner diameter of 392 nm. The parameters were selected so that the resonant wavelength λ falls within the tuning range of our laser (HP Agilent 8618F, tunable from 1440 to 1590 nm). Here the TE-like mode was studied because there is no bandgap for TM-like modes beneath the light cone. The experimental setup (FIG. 4) was the same as that used in Example 1.

To study the spectral response to the capture of a multiple particles, the microcavity was designed with a central defect that has an outer diameter approximately three times larger than the surrounding holes and an inner diameter approximately twice the size of the surrounding holes. The ring width was slightly larger than the diameter of the surrounding pores.

To assess the sensitivity of the PhC, 100 nm latex spheres suspended in solution were exposed to the PhC and then the PhC was dried. In FIG. 1C, multiple latex spheres with a refractive index ˜1.45 are shown captured inside the ring-shaped microcavity. In FIG. 18, the spectrum labeled (a) shows the transmission spectrum before capture, and the spectrum labeled (b) was measured after capture of latex spheres. The resonance red-shifts by approximately 5 nm. These measurements were carried out after the PhC device was dried.

The present invention demonstrates an ultra-sensitive biosensor that contains a 2-D silicon PhC microcavity. Binding of BSA to glutaraldehyde is monitored by measuring the spectral resonance red-shift. This sensor can quantitatively measure the dehydrated protein size. The present device can detect the presence of 2.5 fg of analyte. Its performance can be further improved by increasing the Q factor and positioning the biological substance in the defect region only. Experiments carried on specific biotin-streptavidin model indicate the selectivity of the device.

The present invention also shows that a silicon 2-D PhC-based sensor with a Q of ˜2000 can be used for detecting single particles that have a diameter of ≦50 nm. Thus, after proper functionalization, the device should be able to detect single viral pathogens such as SARS or the H5N1 “bird flu.”

### Example 6

### Model of the Dual-Channel Coupled Photonic Crystal Cavity

Cavities with defects having different radii give rise to resonances at different wavelengths. The transmission spectrum of the 2-D PhC is very sensitive to the specific defect in which the bio-molecule is captured. Hence, when cavities with different radii are functionalized with different probe molecules, one can simultaneously determine the presence or absence of multiple biomolecules by reading an encoded binary signal out of the biosensor chip.

FIG. 1B illustrates a model of one such biosensor chip. The total device size is ˜17 μm², which is comparable to a single cavity PhC biosensor. The coupled-cavity biosensor device will provide redundant detection of the target in a single photonic structure. Capture of a target, e.g., virus particle, in either defect will provide a signal that can either be interpreted as a “conditional positive”, depending on the particular application, while capture of virus particles in both defects will provide a definitive “positive” result. In principle, one can get similar information by pairing differently functionalized single-defect biosensors on a single analytical chip, but the coupled-cavity device provides an advantage by simplifying the steps needed to measure a response (i.e., a single “binary composite” response is measured from the coupled-cavity device, instead of two separate measurements from paired single-defect devices). FIG. 19 shows a model schematic of the dual-channel coupled cavity biosensor readout. Channel 1, produced by cavity A (with a defect radius of r_{A}=0.1 a), and Channel 2, produced by cavity B (with a defect radius of r_{B}=0.2 a) give rise to nearly parallel defect states (band A and band B) with a separation Δωₖ of 0.031. Thus, these two signals produce two distinct output signals that can be separately red-shifted upon target binding.

### Example 7

### Synthesis of Microgel-NTA Particles Loaded with scFV Antibodies and Verification of scFV Antibody Release

Hydrogel nanoparticle synthesis will be based on poly(N-isopropylacrylamide) (PNIPAM) hydrogels. The PNIPAM hydrogel nanoparticles will be synthesized through dispersion polymerization in water (McPhee et al., “Poly(N-isopropylacrylamide) Latices Prepared with Sodium Dodecyl Sulfat,” J. Colloid Int. Sci. 156:24-30 (1993), which is hereby incorporated by reference in its entirety). In a typical dispersion polymerization, the N-isopropylacrylamide monomer, methylenebisacrylamide crosslinker, water soluble free radical initiator (such as ammonium persulfate or potassium persulfate), and surfactant stabilizer (such as sodium dodecyl sulfate) will be dissolved to form a homogeneous aqueous solution. Optionally, a small amount of methacrylic acid or acrylic acid co-monomer can be added (Zhou and Chu, “Synthesis and Volume Phase Transition of Poly(methacrylic acid-co-N-isopropylacrylamide) Microgel Particles in Water,” J. Phys. Chem. B 102:1364-1371 (1998); Snowden et al., “Colloidal Copolymer Microgels of N-isopropylacrylamide and acrylic acid: pH, ionic strength and temperature effects,” J. Chem. Soc., Faraday Trans. 92:5013-5016 (1996), each of which is hereby incorporated by reference in its entirety). The reagents will be heated to 50-70° C. for several hours to complete polymerization. At the reaction temperature, all chemical species are water soluble except the PNIPAM produced by the reaction. As the PNIPAM forms, it precipitates from solution to form nanoparticles that are stabilized by the surfactant. The end result will be a stable colloidal suspension of PNIPAM in water. (Uncrosslinked PNIPAM is water soluble below ˜32° C.) Because the particles will be chemically crosslinked, they cannot dissolve completely in water, but rather swell as temperature is lowered below 32° C. and shrink as temperature is raised above 32° C. The PNIPAM particle diameter is known to change by a factor of ˜2-3 upon changing temperature from 25° C. to 37° C. (McPhee et al., “Poly(N-isopropylacrylamide) Latices Prepared with Sodium Dodecyl Sulfat,” J. Colloid Int. Sci. 156:24-30 (1993); Zhou and Chu, “Synthesis and Volume Phase Transition of Poly(methacrylic acid-co-N-isopropylacrylamide) Microgel Particles in Water,”J. Phys. Chem. B 102:1364-1371 (1998), each of which is hereby incorporated by reference in its entirety).

When methacrylic acid or acrylic acid is copolymerized into the hydrogel, the particles will also display pH dependent swelling due to the ionization of carboxylic acid groups (Snowden et al., “Colloidal Copolymer Microgels of N-isopropylacrylamide and Acrylic Acid: pH, Ionic Strength and Temperature Effects,” J. Chem. Soc., Faraday Trans. 92:5013-5016 (1996); Zhou and Chu, “Synthesis and Volume Phase Transition of Poly(methacrylic acid-co-N-isopropylacrylamide) Microgel Particles in Water,”J. Phys. Chem. B 102:1364-1371 (1998), each of which is hereby incorporated by reference in its entirety). In addition, the degree of temperature induced swelling may be “tuned” by varying the fraction of acrylic acid or methacrylic acid in the PNIPAM-based hydrogel. The degree of temperature induced swelling at a fixed pH will decrease with increasing fraction of acrylic acid or methacrylic acid. For example, pure PNIPAM nanoparticles exhibited a temperature induced change in diameter of a factor of ˜2.8 at pH 7.5, while PNIPAM copolymerized with 2.4% methacrylic acid exhibited a temperature induced change in diameter of a factor of ˜1.6 at pH 7.5 (Zhou and Chu, “Synthesis and Volume Phase Transition of Poly(methacrylic acid-co-N-isopropylacrylamide) Microgel Particles in Water,”J. Phys. Chem. B 102:1364-1371 (1998), which is hereby incorporated by reference in its entirety). The degree of swelling can also be adjusted by varying the crosslink density (Macknova and Horak, “Effects of Reaction Parameters on the Properties of Thermosensitive Poly(N-isopropylacrylamide) Microspheres Prepared by Precipitation and Dispersion Polymerization,” J. Polym. Sci. A: Polym. Chem. 44:968-982 (2006), which is hereby incorporated by reference in its entirety).

The resulting particle size from dispersion polymerization is also known to depend on surfactant concentration, monomer concentration, initiator concentration, fraction of co-monomer, and solvent polarity (Macknova and Horak, “Effects of Reaction Parameters on the Properties of Thermosensitive Poly(N-isopropylacrylamide) Microspheres Prepared by Precipitation and Dispersion Polymerization,” J. Polym. Sci. A: Polym. Chem. 44:968-982 (2006); Kawaguchi and Ito, “Dispersion Polymerization,” Adv. Polym. Sci. 175:299-328 (2005), each of which is hereby incorporated by reference in its entirety). The synthesis conditions employed, therefore, will be adjusted to target different particle sizes. For pure PNIPAM, particle size has been demonstrated to be adjustable from ˜90 nm to ˜700 nm in the swollen state by varying the surfactant concentration used during particle synthesis (McPhee et al., “Poly(N-isopropylacrylamide) Latices Prepared with Sodium Dodecyl Sulfat,” J. Colloid Int. Sci. 156:24-30 (1993), which is hereby incorporated by reference in its entirety). As the surfactant concentration is lowered, the particle size increases. PNIPAM particle size can also be adjusted by adding a small amount of ethanol as a co-solvent to adjust solvent polarity (Macknova and Horak, D., “Effects of Reaction Parameters on the Properties of Thermosensitive Poly(N-isopropylacrylamide) Microspheres Prepared by Precipitation and Dispersion Polymerization,” J. Polym. Sci. A: Polym. Chem. 44:968-982 (2006), which is hereby incorporated by reference in its entirety). PNIPAM particle diameter has been shown to increase from 550 nm to 1.05 microns as ethanol concentration used during synthesis was increased from 0 wt % to 5 wt % (Macknova and Horak, D., “Effects of Reaction Parameters on the Properties of Thermosensitive Poly(N-isopropylacrylamide) Microspheres Prepared by Precipitation and Dispersion Polymerization,” J. Polym. Sci. A: Polym. Chem. 44:968-982 (2006), which is hereby incorporated by reference in its entirety). The PNIPAM particle size has also been shown to be adjustable by varying methacrylic acid co-monomer concentration while holding surfactant concentration fixed. For example, experimental conditions that produce 140 nm diameter pure PNIPAM particles result in 383 nm diameter particles when 10.8% methacrylic acid is copolymerized with the PNIPAM (Zhou and Chu, “Synthesis and Volume Phase Transition of Poly(methacrylic acid-co-N-isopropylacrylamide) Microgel Particles in Water,” J. Phys. Chem. B 102:1364-1371 (1998), which is hereby incorporated by reference in its entirety).

Under appropriate conditions, dispersion polymerization produces PNIPAM particles with near monodisperse particle size distribution. Reports in the literature demonstrate that PNIPAM particles and PNIPAM-methacrylic acid copolymer particles can be synthesized with near monodisperse size distribution and particle diameter ranging from <100 nm to >1000 nm (McPhee et al., “Poly(N-isopropylacrylamide) Latices Prepared with Sodium Dodecyl Sulfat,” J. Colloid Int. Sci. 156:24-30 (1993); Zhou and Chu, “Synthesis and Volume Phase Transition of Poly(methacrylic acid-co-N-isopropylacrylamide) Microgel Particles in Water,” J. Phys. Chem. B 102:1364-1371 (1998); Macknova and Horak, D., “Effects of Reaction Parameters on the Properties of Thermosensitive Poly(N-isopropylacrylamide) Microspheres Prepared by Precipitation and Dispersion Polymerization,” J. Polym. Sci. A: Polym. Chem. 44:968-982 (2006), each of which is hereby incorporated by reference in its entirety). Thus, by adjusting the synthesis conditions, PNIPAM-based hydrogel nanoparticles of controlled size and degree of swelling can be produced.

The surface of the hydrogel nanoparticles will be functionalized with iminodiacetic acid groups. The iminodiacetic acid groups are nickel chelating groups that allow for reversible binding of His₆-tagged proteins to the hydrogel surface. Several researchers have demonstrated surface modification of hydrogel nanoparticles through copolymerization of functional groups during dispersion polymerization. One recent study shows that the addition of a small amount of allylamine to the dispersion polymerization of PNIPAM results in the PNIPAM nanoparticle surface covered in amino groups (Garcia et al., “Photo-, Thermally, and pH-Responsive Microgels,” Langmuir 23:224-229 (2007), which is hereby incorporated by reference in its entirety). That study demonstrated that the PNIPAM nanoparticles can be further surface functionalized by reactions with the surface bound amino groups.

PMIPAM particles with iminodiacetic acid groups will be formed using either one of two approaches. The first involves reacting the amino-functional groups on PNIPAM particles with 1,4-butanediol diglycidyl ether, followed by reaction with iminodiacetic acid, as described recently (Iyer et al., “Development of Environmentally Responsive Hydrogels with Metal Affinity Behavior,” J. Applied Polym. Sci. 105:1210-1220 (2007), which is hereby incorporated by reference in its entirety). Alternatively, N-allyliminodiacetic acid (ALD) monomer will be synthesized through the reaction of allyl bromide and iminodiacetic acid (U.S. Pat. No. 5,256,315 to Lockhart et al., which is hereby incorporated by reference in its entirety). The ALD monomer will be copolymerized during dispersion polymerization to yield PNIPAM particles with surfaces covered by iminodiacetic acid functionality.

Single-chain antibodies (scFv) targeting vaccinia coat proteins A33R and B5R have been selected and amplified from phage-display libraries by Dr. Mark Sullivan's lab at the University of Rochester Medical Center using a process analogous to that described in references (Maguire-Zeiss et al., “Identification of Human alpha-synuclein Specific Single Chain Antibodies,” Biochem. Biophys. Res. Commun. 349:1198-1205 (2006); Shea et al., “Rapid Isolation of Single-chain Antibodies for Structural Genomics,” J. Struct. Funct. Genomics 6:171-175 (2005), each of which is hereby incorporated by reference in its entirety). The binding affinities and selectivities of these scFv antibodies have been thoroughly evaluated via ELISA-type assays. These scFv antibodies will be His₆-tagged.

After completing the synthesis of microgel-NTA particles, it will be verified that they are capable of retaining His-tagged antibodies and proteins in the presence of Ni⁽²⁺⁾, and releasing them in the presence of excess imidazole. To accomplish this, an analogous procedure will be followed for affinity purification of His-tagged proteins (Hengen, “Purification of His-Tag Fusion Proteins from Escherichia coli,” TIBS 20:285-286 (1995), which is hereby incorporated by reference in its entirety). Microgel resin will be loaded into a standard 2 ml disposable chromatography column, and primed with a solution of NiCl₂. The His₆-tagged scFv antibodies will be mixed with a non-tagged (control) protein, and loaded onto the column. After eluting several column volumes of buffer, a solution of 20 mM imidazole will be added to the column, allowing elution of the His₆-tagged scFv. SDS-PAGE gel electrophoresis will be employed to verify selective immobilization of the His₆-tagged scFv (i.e., only a band for the control protein in the column flow-through should be observed), and subsequent release of the protein (i.e., a band for the His₆-scFv following elution with imidazole). The above procedure will also be useful for determining maximum protein loading on this resin.

### Example 8

### Preparation of Single-Defect Biosensor Containing Vaccinia-Specific scFV Antibodies

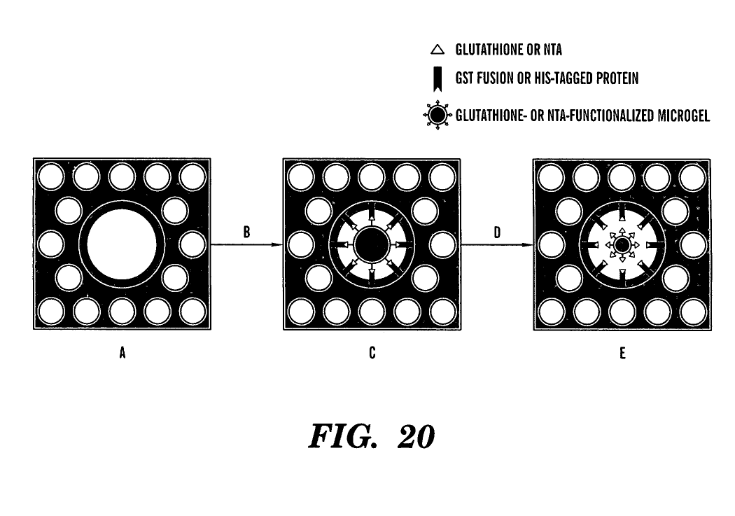

The scFV-loaded particles, prepared in the manner described in prospective Example 7, will be used to transfer scFv to the defect sites of the biosensors of the present invention, and these biosensors will be used to detect Vaccinia virus in samples. Two separate device types will be prepared in parallel: one targeting vaccinia A33R (Roper et al., “Extracellular Vaccinia Virus Envelope Glycoprotein Encoded by the A33R Gene,” J. Virol. 70:3753-3762 (1996), which is hereby incorporated by reference in its entirety), and one targeting vaccinia B5R (Isaacs et al., “Characterization of a Vaccinia Virus-encoded 42-kilodalton Class I Membrane Glycoprotein Component of the Extracellular Virus Envelope,” J. Virol. 66:7217-7224 (1992); Takahashi-Nishimaki et al., “Regulation of Plaque Size and Host Range by a Vaccinia Virus Gene Related to Complement System Proteins,” Virology 181:158-164 (1991), each of which is hereby incorporated by reference in its entirety). The design and fabrication of the biosensor devices will be identical to that described in Examples 1 and 4 above. The methodology for derivatizing these devices will be the same in all cases, and will proceed analogously to methodology as developed (DeLouise et al., “Cross-correlation of Optical Microcavity Biosensor Response with Immobilized Enzyme Activity—Insights into Biosensor Sensitivity,” Anal. Chem. 77:3222-3230 (2005); Mace et al., “A Theoretical and Experimental Analysis of Arrayed Imaging Reflectometry as a Sensitive Proteomics Technique,” Anal. Chem. 78:5578-5583 (2006), each of which is hereby incorporated by reference in its entirety) in the context of porous and planar silicon sensors. First, the device will be treated with aminopropyl(triethoxy)silane (APTES) to yield a uniformly amino-terminated surface. Subsequent treatment with glutaraldehyde will convert this to an amino-reactive (aldehyde) surface (FIG. 20, step A), primed to react with the scFv. Addition of the size-matched microgel bearing the appropriate scFv (FIG. 20, steps B-C), and release of the single-chain antibody and removal of the microgel particle (FIG. 20, steps D-E) will proceed as described schematically above. Subsequent treatment of the device with a solution of bovine serum albumin (BSA) will allow covalent immobilization of BSA on the remainder of the chip surface, which will be useful for blocking nonspecific binding. Note that the chip production process leaves the upper surface unreactive, so it is only possible for protein immobilization to occur inside the defects of the biosensor.

Following preparation of biosensors bearing scFv targeting vaccinia A33R and B5R coat proteins, the ability of these devices to detect vaccinia will be tested. Initial testing will be carried out using pure vaccinia virus in a buffered solution containing 1% bovine serum albumin (BSA) as a carrier. As a negative control, sensors will also be exposed to buffered 1% BSA alone. It is expected that capture of the vaccinia virus will provide a readily detectable spectral shift, while those sensors exposed only to 1% BSA will show a negligible change. The capture of vaccinia by SEM will also be confirmed. The detection limits for the A33R and B5R targeted sensors will be evaluated by exposing a series of devices to increasing tenfold dilutions of virus. Selectivity will be evaluated by comparing the response of scFv-functionalized 2D-PhC biosensors to vaccinia with their response to a solution of similarly sized latex beads.

### Example 9

### Preparation of Coupled-Cavity Biosensor Containing Vaccinia-Specific scFV Antibodies

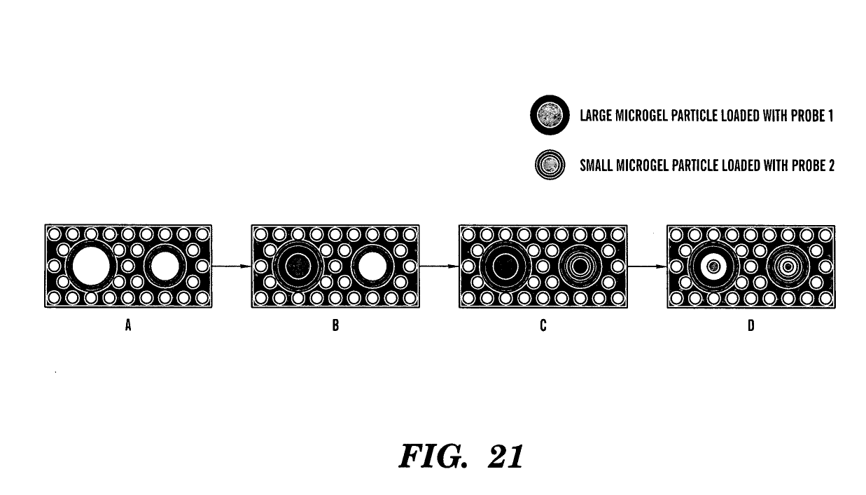

Preparation of the dual-target coupled-cavity (dual-defect) vaccinia biosensor will follow the same general procedure as outlined in prospective Example 8. The dual-defect sensor will be prepared with two differently sized cavities, one being 666 nm and the other being 592 nm. After silanization and treatment with glutaraldehyde (FIG. 21, step A), the chip will be treated at ambient temperature (23° C.) with a solution of 630 nm diameter microgel particles carrying scFv targeting vaccinia A33R (FIG. 21, step B). After allowing sufficient time to elapse for the “large” particles to diffuse into the larger defect hole (and for the proteins they carry to covalently attach to the hole walls, thus preventing diffusion of the particle back out of the hole), the chip will be rinsed briefly and treated with a solution of 560 nm diameter microgel particles bearing scFv targeting vaccinia B5R (FIG. 21, step C). After rinsing away excess particles, the chip will be treated with a solution of 20 mM imidazole, heated to 37° C., and rinsed several times to release His₆-tagged scFv from the particles, and allow for removal of the particles from the two defect holes (FIG. 21, step D).

As in prospective Example 8, initial testing of sensor performance will be carried out using pure vaccinia virus in a buffered solution containing 1% bovine serum albumin (BSA) as a carrier, with 1% BSA alone in buffer as a negative control. The sensitivity of this device will be determined by applying a series of tenfold dilutions (decreasing viral titer) to a set of 10 identical coupled-cavity devices, and a solution containing no virus used as a control. After a 30-minute incubation period, chips will be rinsed with buffer containing 1% BSA and imaged. If sensitivity is found to be poor, then the experiment will be repeated using five-minute sample removal/sample re-application cycles (manual pipetting).

The specificity and selectivity of these coupled-cavity devices will be tested by exposing the sensor to a solution containing vaccinia virus and a tenfold excess of similarly sized latex spheres in buffered 1% BSA. The response of this sensor will be compared with one exposed to an analogous solution lacking vaccinia virus. It is expected that these two sensors will exhibit clearly different responses.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A two-dimensional photonic crystal biosensor chip comprising:
a substrate including a surface having a lattice array of substantially aligned pores therein to form a photonic crystal, the surface also having two or more central defects formed in the lattice array, where the two or more central defects are characterized by resonance modes at different wavelengths of light;
one or more probes bound to surfaces of the substrate exposed to the two or more central defects;
wherein binding of a target to the one or more probes causes a detectable change in a refractive index of the biosensor chip.

2. The biosensor chip according to claim 1, wherein the two or more central defects are characterized by different shapes and/or different defect widths or diameters.

3. The biosensor chip according to claim 1, wherein the pores of the lattice array are characterized by substantially the same diameter, and one or more of the central defects has a width or diameter that is greater than the diameter of surrounding pores.

4. The biosensor chip according to claim 1, wherein the pores of the lattice array are characterized by substantially the same diameter, and one or more of the central defects has a width or diameter that is smaller than the diameter of surrounding pores.

5. The biosensor chip according to claim 1, wherein the pores of the lattice array are characterized by substantially the same diameter, and one or more of the central defects has a width or diameter that is smaller than the pore diameter and one or more of the central defects has a width or diameter that is greater than the pore diameter.

6. The biosensor chip according to claim 1, wherein the one or more probes comprise:
a first probe that recognizes a first target bound to a surface of the substrate exposed to one central defect; and
a second probe that recognizes a second target bound to a surface of the substrate exposed to a different central defect.

7. A two-dimensional photonic crystal biosensor chip comprising:
a substrate including a surface having a lattice array of substantially aligned pores therein to form a photonic crystal, the surface also having a central defect formed in the lattice array, where the central defect is characterized by a radius that is about the distance of (a-d/2) or greater, where a is the lattice constant of the lattice array and d is the diameter of the pores of the array;
one or more probes bound to a surface of the substrate exposed to the central defect;
wherein binding of a target to the one or more probes causes a detectable change in a refractive index of the biosensor chip.

8. A two-dimensional photonic crystal biosensor chip comprising:
a substrate including a surface having a lattice array of substantially aligned pores therein to form a photonic crystal, the surface also having a central defect formed in the lattice array, where the central defect is a closed-loop structure;
one or more probes bound to a surface of the substrate exposed to the central defect;
wherein binding of a target to the one or more probes causes a detectable change in a refractive index of the biosensor chip.

9. The biosensor chip according to claim 8, wherein the closed-loop structure is ring shaped.

10. The biosensor chip according to claim 8, wherein the closed-loop structure has a width that is greater than the diameter of the surrounding pores.

11. The biosensor chip according to claim 1, wherein the one or more probes are selected from the group of peptides and polypeptides, oligonucleotides and nucleic acid molecules having secondary or tertiary structures, small molecules, or a microorganism or fragment thereof possessing surface-exposed epitopes.

12. The biosensor chip according to claim 11, wherein the capture probe is an antibody, an antibody binding fragment, or a polypeptide antibody mimic.

13. The biosensor chip according to claim 12, wherein the antibody is a monoclonal antibody or mono-specific polyclonal antibody population.

14. The biosensor chip according to claim 12, wherein the antibody is immunospecific for a viral particle or viral capsid protein.

15. The biosensor chip according to claim 11, wherein the capture probe is an oligonucleotide.

16. The biosensor chip according to claim 11, wherein the capture probe is a DNA or RNA aptamer.

17. The biosensor chip according to claim 11, wherein the capture probe is a small molecule.

18. The biosensor chip according to claim 1, wherein the detectable change in the refractive index of the biosensor chip is detectable by a resonance wavelength shift of light transmitted through the photonic crystal.

19. The biosensor chip according to claim 1, wherein the substrate comprises a semiconductor material formed over an insulator material.

20. The biosensor chip according to claim 19, wherein the semiconductor material is silicon, n-doped silicon, p-doped silicon.

21. The biosensor chip according to claim 19, wherein the insulator material is an oxide or air/solution interface.

22. The biosensor chip according to claim 21, wherein the oxide is silicon dioxide.

23. The biosensor chip according to claim 1, wherein the pores of the lattice array are coated on their internal surface with a layer of metal.

24. The biosensor chip according to claim 23, wherein the metal is gold, silver, platinum, or palladium.

25. The biosensor chip according to claim 23, wherein the layer of metal is less than about 1 μm thick.

26. A sensor device comprising:
the biosensor chip according to claim 1;
a light source including a first optical waveguide optically coupled to deliver light across the photonic crystal of the biosensor chip; and
a detector including a second optical waveguide optically coupled to receive light output from the photonic crystal of the biosensor chip,
wherein the detector can measure light output from the photonic crystal via the second optical waveguide.

27. The sensor device according to claim 26 further comprising a polarizer positioned between the light source and the photonic crystal.

28. The sensor device according to claim 26, wherein the photonic crystal includes a tapered input facet that receives light from the first optical waveguide.

29. The sensor device according to claim 26, wherein the photonic crystal includes a tapered output facet that outputs light to the second optical waveguide.

30. The sensor device according to claim 26 further comprising two or more of the biosensor chips, each of the biosensor chips being coupled to respective first and second optical waveguides of the light source and the detector.

31. The sensor device according to claim 26 further comprising:
a microfluidic delivery system having a fluid inlet and a fluid outlet, and a passage between the fluid inlet and fluid outlet that communicates with the photonic crystal.

32. The sensor device according to claim 31, wherein device includes a polymer material positioned against at least a portion of the substrate surface, whereby the polymer material and the substrate together define the passage.

33. The sensor device according to claim 32 further comprising a filter positioned upstream of the microfluidic delivery system.

34. A method of making a biosensor chip according to claim 1 comprising:
preparing an array of substantially aligned pores in a substrate to form a photonic crystal having the central defect; and
coupling one or more probes to a surface of the substrate exposed to the central defect.

35. The method of claim 34 further comprising, prior to said coupling:
coating the surface of the central defect with a layer of metal, wherein said coupling involves coupling the one or more probes to the layer of metal.

36. A method of detecting a biological target comprising:
providing a sensor device according to claim 26;
exposing the sensor device to a sample containing a biological target; and
detecting a property of light emitted from the second waveguide, whereby detecting of the property indicates presence of the biological target in the sample.

37. The method according to claim 36, wherein the property of light emitted from the second waveguide is a change in the refractive index of the biosensor chip.

38. The method according to claim 37, wherein the change in the refractive index of the biosensor chip is detectable by a wavelength shift of light transmitted through the photonic crystal.

39. The method according to claim 36, wherein the property of light emitted from the second waveguide is the presence of a signal at a particular wavelength of light.

40. The method according to claim 36, wherein the property of light emitted from the second waveguide is the absence of a signal at a particular wavelength of light.

41. The method according to claim 36 further comprising:
detecting any Raman scattering of light emitted from the biosensor chip.

42. A method of identifying a biological target comprising:
performing the method according to claim 41 and
determining whether the detected Raman scattering confirms the identity of the biological target whose presence is detected by the property of light emitted from the second waveguide.

44. A method of quantifying the amount of a biological target present in a sample comprising:
providing a sensor device according to claim 26;
exposing the sensor device to a sample containing a biological target; and
detecting a change in the refractive index of the biosensor chip, wherein a change in the refractive index indicates presence of the biological target in the sample and the amount of biological target is quantifiable based on the extent of the wavelength shift of light transmitted through the photonic crystal.
